(19) United States
(12) Patent Application Publication
(10) Pub. No.: US 2019/0177243 A1
(43) Pub. Date: Jun. 13, 2019

(54) PRE-CHARGED BIOCHAR AND METHOD THEREFOR

(71) Applicant: HELIAE DEVELOPMENT LLC, Gilbert, AZ (US)

(72) Inventors: Suting Huang, Gilbert, AZ (US); Manikandadas Mathilakathu Madathil, Mesa, AZ (US)

(21) Appl. No.: 16/131,328

(22) Filed: Sep. 14, 2018

Related U.S. Application Data
(60) Provisional application No. 62/595,851, filed on Dec. 7, 2017.
(60) Provisional application No. 62/701,212, filed on Jul. 20, 2018.

(51) Int. Cl. C05F 11/00; C05G 3/00; A01G 24/22; A01C 21/00

(52) U.S. Cl. CPC C05F 11/00; A01C 21/002; A01G 24/22; C05G 3/0041

(57) ABSTRACT

A composition and method for making microalgae pre-charged biochar for use in soil is disclosed. The composition comprises raw biochar and a liquid microalgae composition, wherein the liquid microalgae composition comprises dead pasteurized Chlorella microalgae cells and nutrients that are beneficial to the soil; such as nitrogen, phosphorus, potassium, sulfur, and sodium. The raw biochar and liquid microalgae composition are combined to create a pre-charging mixture, which is then incubated for between 12-24 hours, and dried. The pre-charged biochar is then buried within the vicinity of a fruiting plant, seedling, or seed; between approximately 2-6 deep within the soil.

### CROSS-REFERENCE TO RELATED APPLICATIONS

This application claims the benefit of Provisional Application No. 62/595,851 entitled PRE-CHARGED BIOCHAR, which was filed on Dec. 7, 2017 in the name of the Applicant and which is incorporated herein in full by reference. This application also claims the benefit of Provisional Application No. 62/701,212 entitled PRE-CHARGED BIOCHAR AND METHOD THEREFOR, which was filed on Jul. 20, 2018 in the name of the Applicant and which is incorporated herein in full by reference.

### FIELD OF THE INVENTION

The present invention generally relates to improving soil health and, more specifically, to a microalgae pre-charged biochar and methods for pre-charging raw biochar with microalgae.

### BACKGROUND OF THE INVENTION

Biochar is a recalcitrant form of carbon typically formed by pyrolysis of vegetative matter (e.g., thermochemical conversion of biomass in a reduced oxygen environment), such as charcoal resulting from burning of vegetation (e.g., forest fire). This form of biochar is referred to herein as “raw” because it has not been treated or combined with any other product or material. Biochar is capable of storing carbon for a significantly longer period than if the original biomass (i.e., plant material) had been left to decay. The structure of biochar is extremely porous, which allows it to assimilate nutrients and water from the surrounding environment in a process known as “charging.”

Uncharged biochar acts like a sponge, absorbing soil nutrients until it reaches equilibrium with the soil, thus reaching a charged state; and subsequently acts like a slow-release nutrient reservoir. However, uncharged biochar lies fallow during the charging phase, which sometimes may be for many years.

Some have been known to charge raw biochar with compost or manure in order to accelerate soil recovery and the associated soil microbiological activity. However, when using compost or manure, the composition of the combined product (i.e. compost/manure plus biochar) is inconsistent. Although manure is known to be a source of nutrients such as nitrogen (N), phosphorus (P), and potassium (K), the nutrient content of the manure will vary depending on the source of the compost or manure. For example, the nutrient content of the manure will depend upon the type of animal that created the manure and its diet. Similarly, with compost, the nutrient content of the compost will vary depending upon the raw materials used and the degree of decomposition. Because the nutrient content of the manure and compost cannot be controlled, it is impossible to predict the efficacy of any biochar that is charged with the manure or compost. Furthermore, when using manure or compost, it is difficult to determine whether the manure or compost contains any bacteria and, if so, whether that bacteria would be helpful or harmful to the soil and the plants growing in the soil.

Therefore, a need exists for a composition and method for pre-charging biochar with microalgae so that the nutrients of the pre-charged biochar may be predictable and controlled. By controlling the nutrients in the pre-charged biochar, this helps to minimize any negative side effects of the pre-charged biochar and, conversely, helps to increase positive results from the pre-charged biochar on the soil to which it is applied.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Disclosed herein are techniques and systems for pre-charging biochar with microbials, and the products that result therefrom. In one implementation, microalgae can be combined with biochar to produce a pre-charged biochar, which stacks functions to benefit both the biochar and microalgae product. In essence, the pre-charged biochar creates a slow release function for the microalgae into the soil. Techniques described herein may be used to promote the ability of nutrients and microalgae to adhere to the biochar structure, while mitigating product contamination. As an example, this product could be added to a field during the pre-planting stage (e.g., and later) to help construct soil, conserve water, and retain nutrients, which the plant roots can more efficiently access.

In one implementation, selected raw biochar can be pre-seasoned in a freshwater bath resulting in water-laden biochar. Further, in this implementation, a selected composition of microalgae may be added to the freshwater bath, and the biochar may be allowed to supercharge (incubate) for approximately twelve to twenty-four hours at approximately 37° C., with purging. In this implementation, the resulting product can comprise a biochar charged with microalgae and plant production enhancing nutrients.

In another implementation, a selected composition of microalgae may be directly added to dried raw biochar. The mixture may then be incubated for approximately twelve to twenty-four hours at approximately 37° C.

In accordance with one embodiment of the present invention, a method of pre-charging biochar with microalgae for use in soil is disclosed. The method comprises the steps of: providing an amount of raw biochar; providing an amount of a liquid microalgae composition; mixing the raw biochar with the liquid microalgae composition to create a pre-charging mixture; incubating the pre-charging mixture for between 12-24 hours to create pre-charged biochar; drying the pre-charged biochar; and burying an effective amount of the pre-charged biochar in soil within the vicinity of a fruiting plant, seedling, or seed.

In accordance with another embodiment of the present invention, a method for slow releasing nutrients into soil via pre-charged biochar is disclosed. The method comprises the steps of: pre-charging biochar by: providing an amount of raw biochar; providing an amount of a liquid microalgae composition; mixing the raw biochar with the liquid microalgae composition to create a pre-charging mixture; incubating the pre-charging mixture for between 12-24 hours to create pre-charged biochar; and drying the pre-charged biochar; and burying the pre-charged biochar in the soil within the vicinity of a fruiting plant, seedling, or seed, wherein a ratio of the pre-charged biochar to the soil is 1:1.

In accordance with another embodiment of the present invention, a microalgae pre-charged biochar for slow releasing nutrients into soil is disclosed. The microalgae pre-charged biochar comprises an amount of raw biochar and an amount of a liquid microalgae composition comprising dead pasteurized Chlorella microalgae cells and nutrients beneficial to soil, the nutrients comprising at least one of nitrogen, phosphorus, potassium, sulfur, and sodium; wherein the raw biochar is pre-charged according to the steps of: mixing the raw biochar with the liquid microalgae composition to create a pre-charging mixture, wherein the pre-charging mixture comprises a 1:2 ratio of raw biochar to Chlorella microalgae cells; incubating the pre-charging mixture for between 12-24 hours to create pre-charged biochar; and drying the pre-charged biochar.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The present application is further detailed with respect to the following drawings. These figures are not intended to limit the scope of the present application, but rather, illustrate certain attributes thereof.

FIG. 1 illustrates an exemplary block diagram of a system, in accordance with one or more embodiments of the present invention;

FIG. 2 illustrates a schematic side view of a system, in accordance with one or more embodiments of the present invention;

FIG. 3 illustrates an exemplary block diagram of a system, in accordance with one or more embodiments of the present invention;

FIG. 4 illustrates a system, in accordance with one or more embodiments of the present invention;

FIG. 5 illustrates a perspective view of an exemplary modular bioreactor system in accordance with one or more embodiments of the present invention, shown with modules that can be coupled and decoupled;

FIG. 6 illustrates a perspective view of an exemplary cascading transfer bioreactor system in accordance with one or more embodiments of the present invention;

FIG. 7 illustrates a perspective view of an open raceway pond bioreactor in accordance with one or more embodiments of the present invention, shown with turning vanes and thrusters;

FIG. 8 is a graph showing the percentage charging effect in mass over the control (i.e. raw biochar);

FIG. 9 is a graph showing the relative percentage change over the control (i.e. raw biochar) in active carbon, soil protein, and water holding capacity of soil that is treated with pre-charged biochar that was directly treated with microalgae or that is treated with pre-charged biochar that was pre-seasoned first before being treated with microalgae;

FIG. 10 is a line graph showing a comparison of the change in protein in the soil after being treated with microalgae composition alone, with pre-charged biochar that was directly treated with microalgae, or with pre-charged biochar that was pre-seasoned first before being treated with microalgae;

FIG. 11 is a line graph showing a comparison of the change in active carbon in the soil after being treated with microalgae composition alone, with pre-charged biochar that was directly treated with microalgae, or with pre-charged biochar that was pre-seasoned first before being treated with microalgae;

FIG. 12 is a line graph showing a comparison of the change in water holding capacity in the soil after being treated with microalgae composition alone, with pre-charged biochar that was directly treated with microalgae, or with pre-charged biochar that was pre-seasoned first before being treated with microalgae;

FIG. 13 is line graph showing a comparison of the change in total dissolved solids in the soil after being treated with microalgae composition alone, with pre-charged biochar that was directly treated with microalgae, or with pre-charged biochar that was pre-seasoned first before being treated with microalgae;

FIG. 14 is a line graph showing a comparison of the change in total suspended solids in the soil after being treated with microalgae composition alone, with pre-charged biochar that was directly treated with microalgae, or with pre-charged biochar that was pre-seasoned first before being treated with microalgae; and

FIG. 15 is a graph showing a comparison of the change in nitrogen, phosphorus, potassium, sulfur, and sodium in the soil after being treated with pre-charged biochar that was pre-seasoned first before being treated with microalgae, as compared to soil treated with raw biochar and, and as compared to soil treated with an alternative processed biochar.

### DETAILED DESCRIPTION OF THE INVENTION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

Biochar generally describes vegetative matter or biomass that has undergone thermal decomposition in a reduced oxygen atmosphere (e.g., in order to mitigate combustion); resulting in a solid material of a charcoal-like consistency with a high carbon content. Biochar is a highly porous material that is often used for agricultural purposes, such as to improve soil conditions. Biochar has found other uses, such as to improve resource use efficiency, for remediation and/or mitigation of the effects of environmental pollution, and for greenhouse gas remediation (e.g., carbon dioxide sequestration). The carbon found in the biochar can remain stable for millennia, thereby providing a simple, sustainable means to sequester historic carbon emissions. The creation of biochar from biomass locks approximately 50% of the carbon that the plants absorbed as CO₂ from the atmosphere into the resulting solid. The carbon in biochar is typically inert, with a low chemical and biological reactivity, and is strongly resistant to decomposition.

Biochar can be generated by pyrolyzing a biomass feedstock in the pyrolysis system to produce structured biochar (e.g., having a desirable porosity and/or pore size). As an example, the feedstock to the pyrolysis system can comprise any suitable biomass matter (e.g., vegetative matter), such as seed crops, byproducts in food crop production, waste products from farming, food production, cooking, municipal or other landscaping operations, or other conventional sources, and/or algae. As another example, the pyrolysis system may utilize microwave assisted pyrolysis. Pyrolysis in general, includes the chemical decomposition of hydrocarbon materials by heating in low (e.g., or the absence of) oxygen or any other reagents. Pyrolysis is one way that biochar or charcoal may be produced wherein extremely high temperatures, e.g. 450° C.-500° C., and high pressure is used. For example, pyrolysis, including microwave assisted pyrolysis, is a typical treatment for organic raw material, such as to form biochar. Other systems may include more conventional sources of direct heating of the feedstock in low oxygen atmospheres. The invention disclosed herein does not use pyrolysis because the high temperatures would kill the healthy microbes.

Microalgae are simple, generally aquatic organisms that, like plants, use energy from sunlight to sequester carbon dioxide from the atmosphere into biomass through photosynthesis. Certain strains of microalgae have been used in agriculture for many years as biofertilizer and soil stabilizers. Microalgae has been used in agricultural products and has been known to increase soil water holding capacity after application to plants and/or their surrounding soil. The increase in soil water holding capacity has the potential to improve soil health, reduce water consumption, and enhance productivity in crop plants. Although it has been shown that the application of microalgae alone to soil may improve overall soil health, the co-application and synergistic effects of microalgae, when combined with other products, may yield greater effects.

In one aspect, as disclosed herein, combining a specific composition of a microalgae product with raw biochar, can increase the beneficial effects of biochar and microalgae for plant growth and production. This mixture of the microalgae composition and biochar could be added to a field during the pre-planting stage, for example. In this method, surface mulching or bedding the biochar about 2-6 inches below the ground can be used throughout the entire plant cycle, but may be applied at lower than normal rates. Reapplication of the microalgae pre-charged biochar may be performed, depending on the plant, crop, seasonal variations, etc. In this aspect, the microalgae pre-charged biochar may have an ability to help construct soil, conserve water, and retain nutrients (e.g. nitrogen, phosphorus, potassium, sulfur, calcium, magnesium, iron, zinc, sodium, boron, manganese, copper, etc.)—which the plant roots will be able to access more efficiently.

In one aspect, the biochar can be pre-charged with biologicals, for example, microalgae. In one implementation in this aspect, pre-charging (e.g., resulting in charged biochar) can comprise a process that allows microalgae (e.g., and nutrients) to be deposited into the biochar, such as in the structured portions of the biochar. As an example, structured biochar comprises pores (e.g., the size and number may be varied by the type of feedstock to the pyrolysis, and the heating process used for pyrolysis) which may be nucleation sites for microalgae and/or plant nutrients during the charging process, resulting in biochar that comprises deposits (e.g., stored in the pores) of a desired microalgae composition. For example, a microalgae composition may comprise one or more species or types of microalgae, as described below.

In one implementation, in this aspect, a structured raw biochar (e.g., selected for pore size and overall porosity based on the target vegetation) can be pre-seasoned with fresh water, in a bath, drum, or other type of vessel. Pre-seasoning can comprise the step of soaking the raw biochar for between 12-24 hours in water that is at room temperature (20° C.-25° C.). Soaking the raw biochar in water helps to open the pores of the biochar in order to allow water to penetrate at least a portion of the pores in the biochar (e.g., and be stored within). In this implementation, after the biochar is pre-seasoned with water, the raw biochar is removed from the water so that excess water may be drained from it. A microalgae composition is then added to the wet raw biochar at room temperature (20° C.-25° C.) to create a pre-charging mixture comprising a 1:2 ratio of raw biochar to microalgae cells. In order to do this, a microalgae composition may be added to the pre-seasoning water (or the pre-seasoning water can be drained, or biochar removed, and a new solution with the microalgae can be added to the biochar). Alternatively, the wet raw biochar may be added to another container that houses the microalgae composition. The pre-charging mixture comprising the raw biochar and the microalgae composition may then be incubated until fully charged; e.g. for approximately 12-24 hours.

In another implementation, a selected composition of microalgae may be directly added to dry raw biochar to create the pre-charging mixture; i.e. the microalgae composition may be added to the dry raw biochar without pre-seasoning the biochar in water. The microalgae composition may be added to the raw biochar at room temperature (20° C.-25° C.) to create a pre-charging mixture comprising a 1:2 ratio of raw biochar to microalgae cells. In order to do this, the dry raw biochar may be added to container that houses the microalgae composition. The pre-charging mixture comprising the raw biochar and the microalgae composition may then be incubated until fully charged; e.g. for approximately 12-24 hours.

For both charging methods, incubation of the pre-charging mixture comprises the steps of heating and purging. The purpose of heating the pre-charging mixture is to heat up the biochar enough to open its pores so that the microalgae and nutrients may enter the pores and remain in the pores of the biochar. While heating the pre-charging mixture at 37° C., for either the first charging method or the second charging method, is the optimal temperature to allow all of the beneficial microbes in the microalgae to thrive, it should be clearly understood that substantial benefit may still be achieved if the biochar is heated at an alternative temperature between the range of 24° C.-60° C. The appropriate temperature for heating the pre-charging mixture will be any temperature that will allow the biochar to heat up enough to open the pores of the biochar so that the microalgae and nutrients may enter the pores and remain in the pores of the biochar. Deviation from the ideal 37° C. heating temperature may require adjustment to the duration of the heating period. For example, heating at a lower temperature of 24° C. may require that the biochar be allowed to heat for a longer period of time; e.g. 7 days. As a further example, heating at a higher temperature of 60° C. may require that the biochar be heated for less than 12 hours in order to prevent the healthy microbes from being deactivated by the heat. When the pre-charged biochar is harvested, it is rinsed with very cold water in order to close its pores and seal the microalgae and nutrients within the pores of the biochar. Any excess microalgae is removed from the pre-charged biochar and the pre-charged biochar is then dried at a temperature between 75° C.-105° C., where 105° C. would be optimal, to further seal the microalgae and nutrients into the pre-charged biochar.

For both charging methods, purging comprises the steps of pumping atmospheric gas through a tube and into the culture contained within an incubator with a cap and vacuum seal so that the only air coming in is through the tube. Air is pumped into the air for the whole incubation period at a flow rate of 90-120 gallons/hour; e.g. 24 hours. This purging process: 1) helps to avoid bacterial contamination; and 2) helps the microalgae and nutrients penetrate the pores of the biochar. If there were no pumping of air, there would be no circulation, which may cause the healthy microbes (under heat) to become deactivated from anaerobic decomposition.

Both charging processes are conducted without high pressure. If the biochar was pre-charged at high pressures, the healthy microbes would become deactivated. Therefore, both charging processes are conducted at atmospheric pressure.

In one implementation, the microalgae composition can comprise 10% w/w mixture of solid microalgae cells. Further, the pre-seasoned biochar can be exposed to the microalgae composition during a supercharging stage, which may comprise from 12-24 hours (e.g., or less, or more). In one example, the mixture may be purged periodically (e.g., one or more times). In this implementation, for example, this process can promote nutrients and microalgae to adhere to the biochar, such as in the nucleation sites of the pores of the biochar; and may also mitigate contamination of the resulting “charged” biochar.

In this aspect, the efficacy of a resulting product (e.g., of the biochar charging process), has been demonstrated, through multiple lab and field experiments, to increase soil water holding capacity by at least 2.5 times over untreated soil, after application of the microalgae-charged biochar products in agricultural applications. For example, this result allows the potential to improve soil health, reduce water consumption, and enhance productivity in crop plants.

The term “microalgae” refers to microscopic single cell organisms such as microalgae, cyanobacteria, algae, diatoms, dinoflagellates, freshwater organisms, marine organisms, or other similar single cell organisms capable of growth in phototrophic, mixotrophic, or heterotrophic culture conditions.

In some embodiments, microalgae biomass, excreted products, or extracts may be sourced from multiple types of microalgae, to make a composition that is beneficial when applied to plants or soil. Non-limiting examples of microalgae that can be used in the compositions and methods of the present invention comprise microalgae in the classes: Eustigmatophyceae, Chlorophyceae, Prasinophyceae, Haptophyceae, Cyanidiophyceae, Prymnesiophyceae, Porphyridiophyceae, Labyrinthulomycetes, Trebouxiophyceae, Bacillariophyceae, and Cyanophyceae. The class Cyanidiophyceae includes species of Galdieria. The class Chlorophyceae includes species of Chlorella, Haematococcus, Scenedesmus, Chlamydomonas, and Micractinium. The class Prymnesiophyceae includes species of Isochrysis and Pavlova. The class Eustigmatophyceae includes species of Nannochloropsis. The class Porphyridiophyceae includes species of Porphyridium. The class Labyrinthulomycetes includes species of Schizochytrium and Aurantiochytrium. The class Prasinophyceae includes species of Tetraselmis. The class Trebouxiophyceae includes species of Chlorella. The class Bacillariophyceae includes species of Phaeodactylum. The class Cyanophyceae includes species of Spirulina.

Non-limiting examples of microalgae genus and species that can be used in the compositions and methods of the present invention, alone or in combination, include: Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Aurantiochytrium sp., Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomonas sp., Chlamydomas perigranulata, Chlorella anitrata, Chlorella Antarctica, Chlorella aureoviridis, Chlorella Candida, Chlorella capsulate, Chlorella desiccate, Chlorella ellipsoidea, Chlorella emersonii, Chlorella fusca, Chlorella fusca var. vacuolate, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Galdieria sp., Gleocapsa sp., Gloeothamnion sp., Haematococcus pluvialis, Hymenomonas sp., Isochrysis aff. galbana, Isochrysis galbana, Lepocinclis, Micractinium, Monoraphidium minutum, Monoraphidium sp., Nannochloris sp., Nannochloropsis salina, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Platymonas sp., Pleurochrysis camerae, Pleurochrysis dentate, Pleurochrysis sp., Porphyridium sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf, Tagetes erecta, Tagetes patula, Tetraedron, Tetraselmis sp., Tetraselmis suecica, Thalassiosira weissflogii, and Viridiella fridericiana.

Taxonomic classification has been in flux for organisms in the genus Schizochytrium. Some organisms previously classified as Schizochytrium have been reclassified as Aurantiochytrium, Thraustochytrium, or Oblongichytrium. See Yokoyama et al. Taxonomic rearrangement of the genus Schizochytrium sensu lato based on morphology, chemotaxonomic characteristics, and 18S rRNA gene phylogeny (Thrausochytriaceae, Labyrinthulomycetes): emendation for Schizochytrium and erection of Aurantiochytrium and Oblongichytrium gen. nov. Mycoscience (2007) 48:199-211. Those of skill in the art will recognize that Schizochytrium, Aurantiochytrium, Thraustochytrium, and Oblongichytrium appear closely related in many taxonomic classification trees for microalgae, and strains and species may be reclassified from time to time. Thus, for references throughout the instant specification for Schizochytrium, it is recognized that microalgae strains in related taxonomic classifications with similar characteristics to Schizochytrium, such as Aurantiochytrium, would reasonably be expected to produce similar results.

In some embodiments, the microalgae may be cultured in phototrophic, mixotrophic, or heterotrophic culture conditions in an aqueous culture medium. The organic carbon sources suitable for growing microalgae mixotrophically or heterotrophically may comprise: acetate, acetic acid, ammonium linoleate, arabinose, arginine, aspartic acid, butyric acid, cellulose, citric acid, ethanol, fructose, fatty acids, galactose, glucose, glycerol, glycine, lactic acid, lactose, maleic acid, maltose, mannose, methanol, molasses, peptone, plant based hydrolyzate, proline, propionic acid, ribose, saccharose, partial or complete hydrolysates of starch, sucrose, tartaric, TCA-cycle organic acids, thin stillage, urea, industrial waste solutions, yeast extract, and combinations thereof. The organic carbon source may comprise any single source, combination of sources, and dilutions of single sources or combinations of sources. In some embodiments, the microalgae may be cultured in axenic conditions. In some embodiments, the microalgae may be cultured in non-axenic conditions.

In one non-limiting embodiment, the microalgae of the culture in an aqueous culture medium may comprise Chlorella sp. cultured in mixotrophic conditions comprising a culture medium primary comprised of water with trace nutrients (e.g., nitrates, phosphates, vitamins, metals found in BG-11 recipe [available from UTEX The Culture Collection of Algae at the University of Texas at Austin, Austin, Tex.]), light as an energy source for photosynthesis, and organic carbon (e.g., acetate, acetic acid) as both an energy source and a source of carbon. In some embodiments, the culture media may comprise BG-11 media or a media derived from BG-11 culture media (e.g., in which additional component(s) are added to the media and/or one or more elements of the media is increased by 5%, 10%, 15%, 20%, 25%, 33%, 50%, or more over unmodified BG-11 media). In some embodiments, the Chlorella may be cultured in non-axenic mixotrophic conditions in the presence of contaminating organisms, such as but not limited to bacteria. Additional detail on methods of culturing such microalgae in non-axenic mixotrophic conditions may be found in WO2014/074769A2 (Ganuza, et al.), which is incorporated herein in full by reference.

In some embodiments, by artificially controlling aspects of the microalgae culturing process such as the organic carbon feed (e.g., acetic acid, acetate), oxygen levels, pH, and light, the culturing process differs from the culturing process that microalgae experiences in nature. In addition to controlling various aspects of the culturing process, intervention by human operators or automated systems occurs during the non-axenic mixotrophic culturing of microalgae through contamination control methods to prevent the microalgae from being overrun and outcompeted by contaminating organisms (e.g., fungi, bacteria). Contamination control methods for microalgae cultures are known in the art and such suitable contamination control methods for non-axenic mixotrophic microalgae cultures are disclosed in WO2014/074769A2 (Ganuza, et al.), which is incorporated herein in full by reference. By intervening in the microalgae culturing process, the impact of the contaminating microorganisms can be mitigated by suppressing the proliferation of contaminating organism populations and the effect on the microalgal cells (e.g., lysing, infection, death, clumping). Thus, through artificial control of aspects of the culturing process and intervening in the culturing process with contamination control methods, the microalgae culture produced as a whole and used in the described inventive compositions differs from the culture that results from a microalgae culturing process that occurs in nature.

In some embodiments, during the culturing process the microalgae culture may also comprise cell debris and compounds excreted from the microalgae cells into the culture medium. The output of the microalgae culturing process provides the active ingredient for composition that is applied to plants for improving yield and quality without separate addition to or supplementation of the composition with other active ingredients not found in the mixotrophic microalgae whole cells and accompanying culture medium from the culturing process such as, but not limited to: microalgae extracts, macroalgae, macroalgae extracts, liquid fertilizers, granular fertilizers, mineral complexes (e.g., calcium, sodium, zinc, manganese, cobalt, silicon), fungi, bacteria, nematodes, protozoa, digestate solids, chemicals (e.g., ethanolamine, borax, boric acid), humic acid, nitrogen and nitrogen derivatives, phosphorus rock, pesticides, herbicides, insecticides, enzymes, plant fiber (e.g., coconut fiber).

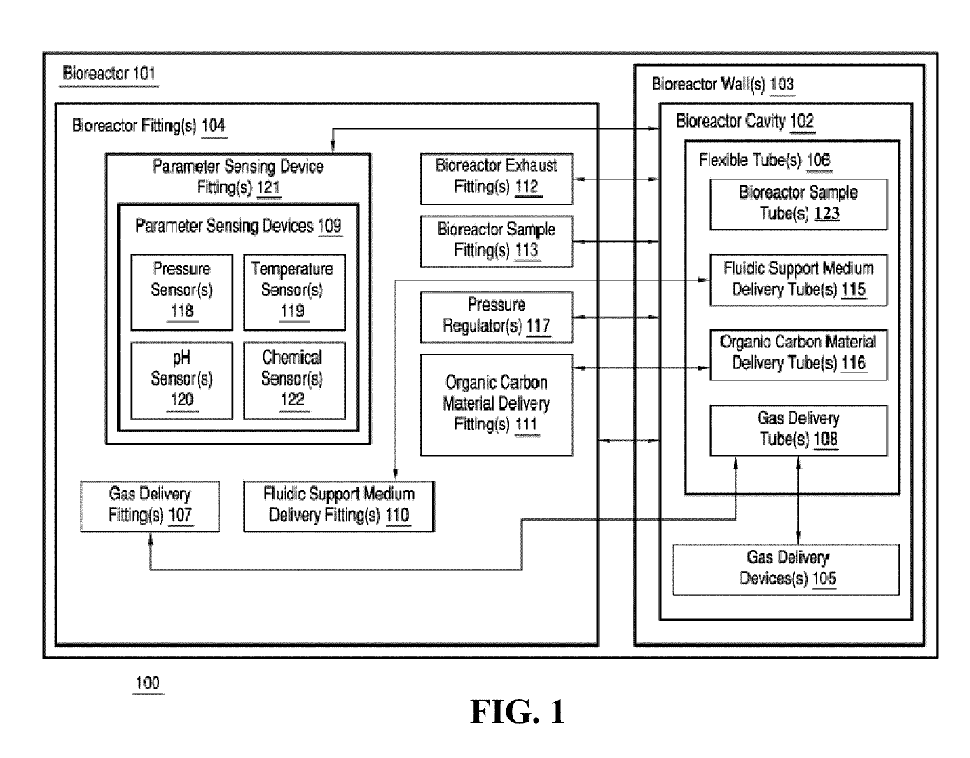

FIG. 1 illustrates an exemplary block diagram of a system 100, according to an embodiment. System 100 is merely exemplary and is not limited to the embodiments presented herein. System 100 can be employed in many different embodiments or examples not specifically depicted or described herein and such adjustments or changes can be selected by one or ordinary skill in the art without departing from the scope of the subject innovation.

System 100 comprises a bioreactor 101 that includes a bioreactor cavity 102 and one or more bioreactor walls 103. Further, bioreactor 101 can include one or more bioreactor fittings 104, one or more gas delivery devices 105, one or more flexible tubes 106, one or more parameter sensing devices 109, and/or one or more pressure regulators 117.

In many embodiments, bioreactor fitting(s) 104 can include one or more gas delivery fittings 107, one or more fluidic support medium delivery fittings 110, one or more organic carbon material delivery fittings 111, one or more bioreactor exhaust fittings 112, one or more bioreactor sample fittings 113, and/or one or more parameter sensing device fittings 121. In these or other embodiments, flexible tube(s) 106 can include one or more gas delivery tubes 108, one or more organic carbon material delivery tubes 116, one or more bioreactor sample tubes 123, and/or one or more fluidic support medium delivery tubes 115. Further, in these or other embodiments, parameter sensing device(s) 109 can include one or more pressure sensors 118, one or more temperature sensors 119, one or more pH sensors 120, and/or one or more chemical sensors 122.

Bioreactor 101 is operable to vitally support (e.g., sustain, grow, nurture, cultivate, among others) one or more organisms (e.g., one or more macroorganisms, one or more microorganisms, and the like). In these or other embodiments, the organism(s) can include one or more autotrophic organisms or one or more heterotrophic organisms. In further embodiments, the organism(s) can comprise one or more mixotrophic organisms. In many embodiments, the organism(s) can comprise one or more phototrophic organisms. In still other embodiments, the organism(s) can comprise one or more genetically modified organisms. In some embodiments, the organism(s) vitally supported by bioreactor 101 can comprise one or more organism(s) of a single type, multiple single organisms of different types, or multiple ones of one or more organisms of different types.

In many embodiments, exemplary microorganism (s) that bioreactor 101 may be implemented to vitally support can include algae (e.g., microalgae), fungi (e.g., mold), and/or cyanobacteria. For example, in many embodiments, bioreactor 101 can be implemented to vitally support multiple types of microalgae such as, but not limited to, microalgae in the classes: Eustigmatophyceae, Chlorophyceae, Prasinophyceae, Haptophyceae, Cyanidiophyceae, Prymnesiophyceae, Porphyridiophyceae, Labyrinthulomycetes, Trebouxiophyceae, Bacillariophyceae, and Cyanophyceae. The class Cyanidiophyceae includes species of Galdieria. The class Chlorophyceae includes species of Chlorella, Haematococcus, Scenedesmus, Chlamydomonas, and Micractinium. The class Prymnesiophyceae includes species of Isochrysis and Pavlova. The class Eustigmatophyceae includes species of Nannochloropsis. The class Porphyridiophyceae includes species of Porphyridium. The class Labyrinthulomycetes includes species of Schizochytrium and Aurantiochytrium. The class Prasinophyceae includes species of Tetraselmis. The class Trebouxiophyceae includes species of Chlorella. The class Bacillariophyceae includes species of Phaeodactylum. The class Cyanophyceae includes species of Spirulina. Further still, in many embodiments, bioreactor 101 can be implemented to vitally support microalgae genus and species as described herein.

Bioreactor cavity 102 can hold (e.g., contain or store) the organism(s) being vitally supported by bioreactor 101, and in many embodiments, also can contain a fluidic support medium configured to hold, and in many embodiments, submerge the organism(s). In many embodiments, the fluidic support medium can comprise a culture medium, and the culture medium can comprise, for example, water. The bioreactor cavity 102 can be at least partially formed and enclosed by one or more bioreactor wall(s) 103. When the bioreactor 101 is implemented with bioreactor fitting(s) 104, bioreactor fitting(s) 104 together with bioreactor wall(s) 103 can fully form and enclose bioreactor cavity 102. Further, as explained in greater detail below, bioreactor wall(s) 103 and one or more of bioreactor fitting(s) 104, as applicable, can be operable to at least partially (e.g., fully) seal the contents of bioreactor cavity 102 (e.g., the organism(s) and/or fluidic support medium) within bioreactor cavity 102. As a result, the bioreactor 101 can maintain conditions mitigating the risk of introducing foreign (e.g., unintended) and/or contaminating organisms to bioreactor cavity 102. In other words, bioreactor 101 can engender the dominance (e.g., proliferation) of certain (e.g., intended) organism(s) being vitally supported at bioreactor 102 over foreign (e g, unintended) and/or contaminating organisms. For example, bioreactor 101 can maintain substantially (e.g., absolutely) axenic conditions in the bioreactor cavity 102.

Bioreactor wall(s) 103 comprise one or more bioreactor wall materials. When bioreactor wall(s) 103 comprise multiple bioreactor walls, two or more of the bioreactor walls can comprise the same bioreactor wall material(s) and/or two or more of the bioreactor walls can comprise different bioreactor wall material(s). In many embodiments, part or all of the bioreactor wall material(s) can comprise (e.g., consist of) one or more flexible materials. In some embodiments, bioreactor 101 can comprise a bag bioreactor.

In these or other embodiments, part or all of the bioreactor wall material(s) (e.g., the flexible material(s)) can comprise one or more partially transparent (e.g., fully transparent) and/or partially translucent (e.g., fully translucent) materials, such as, for example, when bioreactor 101 comprises a photobioreactor (e.g., when the organism(s) comprise phototrophic organism(s)). For example, implementing the bioreactor wall material(s) (e.g., the flexible material(s)) with at least partially transparent or translucent materials can permit light radiation to pass through bioreactor wall(s) 103 to be used as an energy source by the organism(s) contained at bioreactor cavity 102. Still, in some embodiments, bioreactor 101 can vitally support phototrophic organisms when the bioreactor wall material(s) (e.g., the flexible material(s)) of bioreactor wall(s) 103 are opaque, such as, for example, by providing sources of light radiation internal to bioreactor cavity 102. Further, in some embodiments, part or all of the bioreactor wall material(s) (e.g., the flexible material(s)) can comprise one or more selectively partially transparent (e.g., fully transparent) and/or partially translucent (e.g., fully translucent) materials, able to shift from opaque to at least partial transparency (e.g., full transparency) or at least partial translucency (e.g., full translucency).

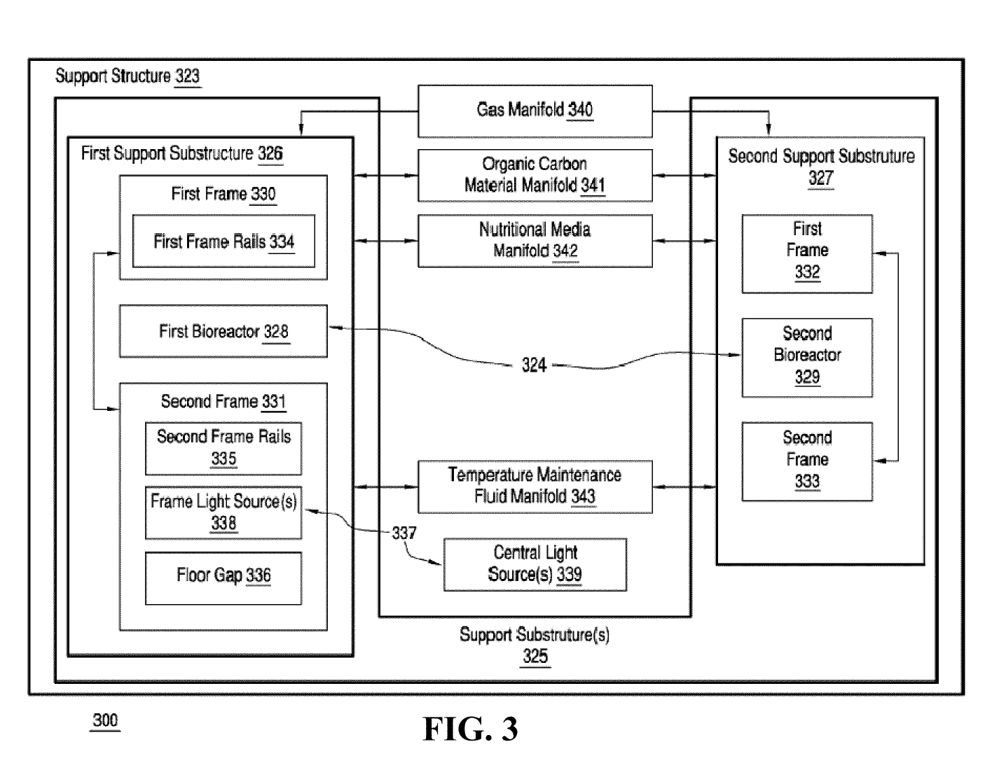

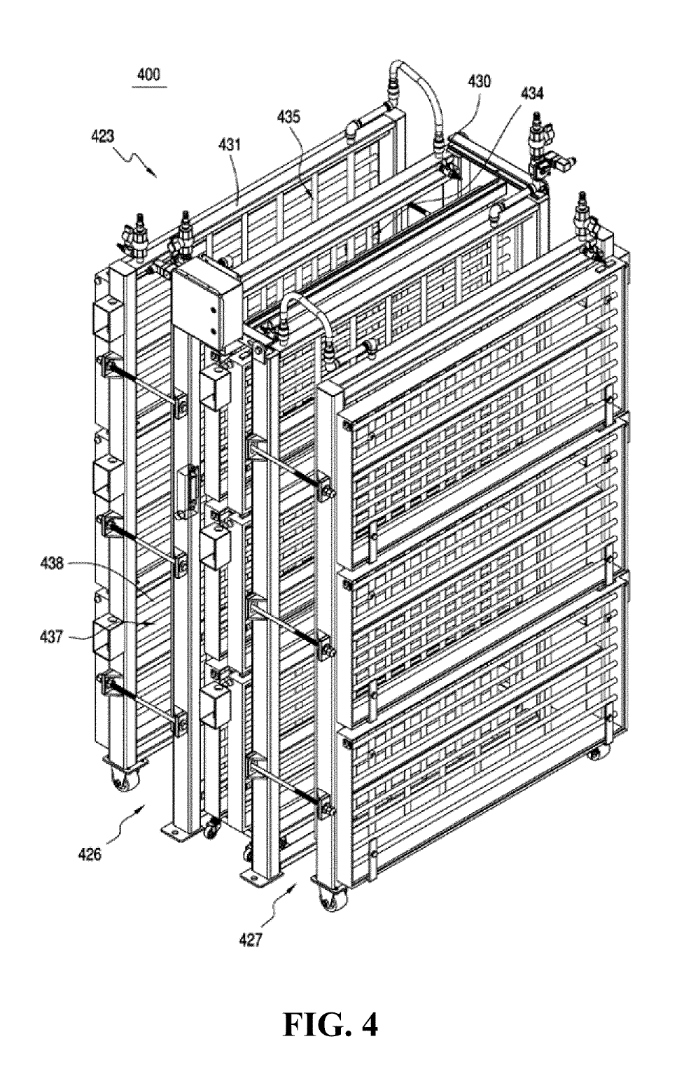

Bioreactor cavity 102 can comprise a cavity volume. The cavity volume of bioreactor cavity 102 can comprise any desirable volume. However, in some embodiments, the cavity volume can be constrained by an available geometry (e.g., the dimensions) of the sheet material(s) used to manufacture bioreactor wall(s) 103. Other factors that can constrain the cavity volume can include a light penetration depth through bioreactor wall(s) 103 and into bioreactor cavity 102 (e.g., when the organism(s) vitally supported by bioreactor 101 are phototrophic organism(s)), a size of an available autoclave for sterilizing bioreactor 101, and/or a size of a support structure implemented to mechanically support bioreactor 101. For example, the support structure can be similar or identical to support structure 323 (shown in FIG. 3) and/or support structure 423 (as shown in FIG. 4).

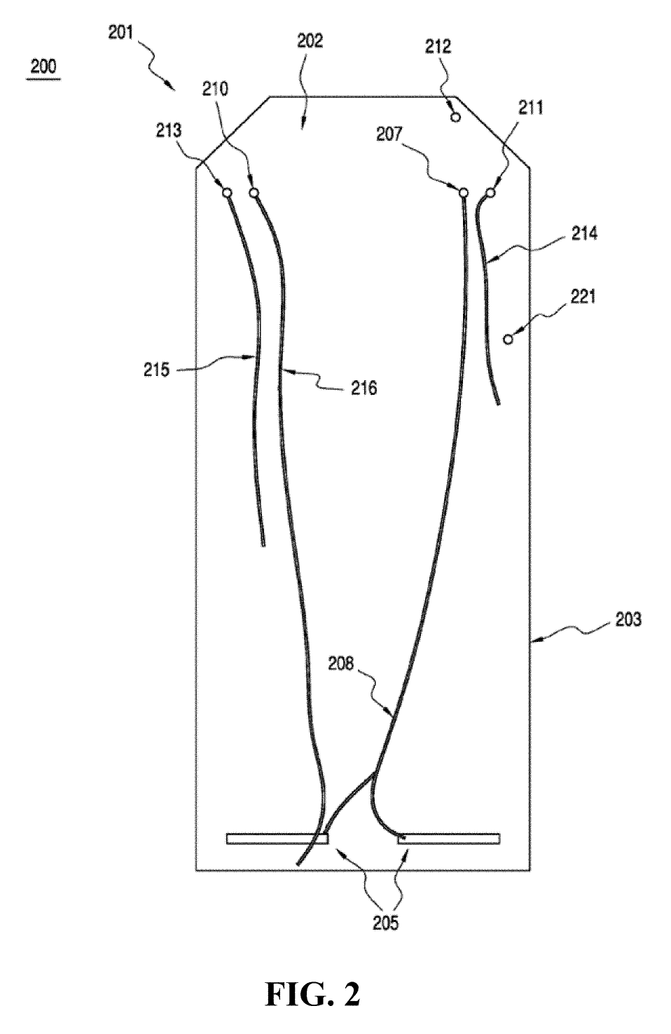

FIG. 2 illustrates a schematic side view of a system 200, according to an embodiment. System 200 is a non-limiting example of system 100 (as shown in FIG. 1). Yet, system 200 of FIG. 2 can be modified or substantially similar to the system 100 of FIG. 1 and such modifications can be selected by one or ordinary skill in the art without departing from the scope of this innovation.

System 200 can comprise bioreactor 201, bioreactor cavity 202, one or more bioreactor walls 203, one or more gas delivery devices 205, one or more gas delivery fittings 207, one or more gas delivery tubes 208, one or more fluidic support medium delivery fittings 210, one or more organic carbon material delivery fittings 211, one or more bioreactor exhaust fittings 212, one or more bioreactor sample fittings 213, one or more organic carbon material delivery tubes 214, one or more bioreactor sample tubes 215, one or more fluidic support medium delivery tubes 216, and one or more parameter sensing device fittings 221. In some embodiments, bioreactor 201 can be similar or identical to bioreactor 101 (as shown in FIG. 1); bioreactor cavity 202 can be similar or identical to bioreactor cavity 102 (as shown in FIG. 1); bioreactor wall(s) 203 can be similar or identical to bioreactor wall(s) 103 (as shown in FIG. 1); gas delivery device(s) 205 can be similar or identical to gas delivery device(s) 105 (as shown in FIG. 1); gas delivery fitting(s) 207 can be similar or identical to gas delivery fitting(s) 107 (as shown in FIG. 1); gas delivery tube(s) 208 can be similar or identical to gas delivery tube(s) 108 (as shown in FIG. 1); fluidic support medium delivery fitting(s) 210 can be similar or identical to fluidic support medium delivery fitting(s) 110 (as shown in FIG. 1); organic carbon material delivery fitting(s) 211 can be similar or identical to organic carbon material delivery fitting(s) 111 (as shown in FIG. 1); bioreactor exhaust fitting(s) 212 can be similar or identical to bioreactor exhaust fitting(s) 112 (as shown in FIG. 1); bioreactor sample fitting(s) 213 can be similar or identical to bioreactor sample fitting(s) 113 (as shown in FIG. 1); organic carbon material delivery tube(s) 214 can be similar or identical to organic carbon material delivery tube(s) 116 (as shown in FIG. 1); bioreactor sample tube(s) 215 can be similar or identical to bioreactor sample tube(s) 123 (as shown in FIG. 1); fluidic support medium delivery tube(s) 216 can be similar or identical to fluidic support medium delivery tube(s) 115 (as shown in FIG. 1); and/or parameter sensing device fitting(s) 221 can be similar or identical to parameter sensing device fitting(s) 121 (as shown in FIG. 1).

Turning ahead now in the drawings, FIG. 3 illustrates an exemplary block diagram of a system 300, according to an embodiment. System 300 is merely exemplary and is not limited to the embodiments presented herein. System 300 can be employed in many different embodiments or examples not specifically depicted or described herein.

System 300 comprises a support structure 323. As explained in greater detail below, support structure 323 is operable to mechanically support one or more bioreactors 324. In these or other embodiments, as also explained in greater detail below, support structure 323 can be operable to maintain a set point temperature of one or more of bioreactor(s) 324. In many embodiments, one or more of bioreactor(s) 324 can be similar or identical to bioreactor 101 (as shown in FIG. 1) and/or bioreactor 201 (as shown in FIG. 2). Accordingly, the term set point temperature can refer to the set point temperature as defined above with respect to system 100 (as shown in FIG. 1). Further, when bioreactor(s) 324 comprise multiple bioreactors, two or more of bioreactor(s) 324 can be similar or identical to each other and/or two or more of bioreactor(s) 324 can be different form each other. For example, the bioreactor wall materials of the bioreactor walls of two or more of bioreactor(s) 324 can be different. In some embodiments, system 300 can comprise one or more of bioreactor(s) 324.

In many embodiments, support structure 323 comprises one or more support substructures 325. Each support substructure of support substructure(s) 325 can mechanically support one bioreactor or more bioreactor(s) 324. In these or other embodiments, each support substructure of support substructure(s) 325 can maintain a set point temperature of one bioreactor of bioreactor(s) 324. In further embodiments, each of support substructure(s) 325 can be similar or identical to each other.

For example, support substructure(s) 325 can comprise a first support substructure 326 and a second support substructure 327. In these embodiments, first support substructure 326 can mechanically support a first bioreactor 328 of bioreactor(s) 324, and second support substructure 327 can mechanically support a second bioreactor 329 of bioreactor(s) 324. Further, first support substructure 326 can comprise a first frame 330 and a second frame 331, and second support substructure 327 can comprise a first frame 332 and a second frame 333. In many embodiments, first frame 330 can be similar or identical to first frame 332, and second frame 331 can be similar or identical to second frame 333. Further, first frame 330 can be similar to second frame 331, and first frame 332 can be similar to second frame 333. It is to be appreciated that the first support substructure 326 can include one or more frames of a first material and the second support substructure 327 can include one or more frames of a second material.

As indicated above, first support substructure 326 can be similar or identical to second support substructure 327. Accordingly, to increase the clarity of the description of system 300 generally, the description of second support substructure 327 is limited so as not to be redundant with respect to first support substructure 326.

In many embodiments, first frame 330 and second frame 331 together can mechanically support first bioreactor 328 in interposition between first frame 330 and second frame 331. That is, bioreactor 328 can be sandwiched between first frame 330 and second frame 331 at a slot formed between first frame 330 and second frame 331. In these or other embodiments, first frame 330 and second frame 331 together can mechanically support first bioreactor 328 in an approximately vertical orientation. Further, first frame 330 and second frame 331 can be oriented approximately parallel to each other. In another embodiment, the first frame 330 and the second frame 331 can be perpendicular to one another.

In many embodiments, second frame 331 can be selectively moveable relative to first frame 330 so that the volume of the slot formed between first frame 330 and second frame 331 can be adjusted. For example, second frame 331 can be supported by one or more wheels permitting second frame 331 to be rolled closer to or further from first frame 330. Meanwhile, in these or other embodiments, second frame 331 can be coupled to first frame 330 by one or more adjustable coupling mechanisms. The adjustable coupling mechanism(s) can hold second frame 331 in a desired position relative to first frame 330 while being adjustable so that the position can be changed when desirable. In implementation, the adjustable coupling mechanism (s) can comprise one or more threaded screws extending between first frame 330 and second frame 331, such as, for example, in a direction orthogonal to first frame 330 and second frame 331. Turning the threaded screws can cause second frame 331 to move (e.g., on the wheel(s)) relative to first frame 330.

Meanwhile, in some embodiments, first frame 330 can be operable to maintain a set point temperature of first bioreactor 328 when first bioreactor 328 is operating to vitally support one or more organisms and when support structure 300 (e.g., first support substructure 326, first frame 330, and/or second frame 331) is mechanically supporting first bioreactor 328. In these or other embodiments, second frame 331 can be operable to maintain the set point temperature of first bioreactor 328 when first bioreactor 328 is operating to vitally support the organism(s) and when support structure 300 (e.g., second support substructure 327, first frame 330, and/or second frame 331) is mechanically supporting first bioreactor 328.

As indicated above, in many embodiments, in many embodiments, second frame 331 can be similar or identical to first frame 330. Accordingly, second frame 331 can comprise multiple second frame rails 335. Meanwhile, second frame rails 335 can be similar or identical to first frame rails 334. In some embodiments, the hollow conduits of first frame rails 334 can be coupled to hollow conduits of 335. In these embodiments, the hollow conduits of first frame rails 334 and second frame rails 335 can receive the temperature maintenance fluid from the same source. However, in these or other embodiments, the hollow conduits of first frame rails 334 and the hollow conduits of second frame rails 335 can receive the temperature maintenance fluid from different sources.

In many embodiments, first support substructure 326 comprises a floor gap 336. Floor gap 336 can be located underneath one of first frame 330 or second frame 331. Floor gap 336 can permit first bioreactor 328 to bulge into floor gap 336 past first support substructure 326 when first support substructure 326 is mechanically supporting first bioreactor 328. Permitting first bioreactor 328 to bulge into floor gap 336 can relieve stress from first bioreactor 328. For example, in many embodiments, bioreactor(s) 324 can experience the greatest amount of stress at their base(s) when being mechanically supported in a vertical position, such as, for example, by support structure 323. In these embodiments, permitting first bioreactor 328 to bulge into floor gap 336 such that first support substructure 326 is not restraining first bioreactor 328 at floor gap 336 can relieve more stress from first bioreactor 328 than constraining all of first bioreactor 328 at both sides with first frame 330 and second frame 331, even if first frame 330 and second frame 331 are reinforced.

System 300 (e.g., support structure 323) can comprise one or more light sources 337. Light source(s) 337 can be operable to illuminate the organism(s) being vitally supported at bioreactor(s) 324. In many embodiments, second frame 331 can comprise and/or mechanically support one or more frame light source(s) 338 of light source(s) 337. Meanwhile, system 300 (e.g., support structure 323) can comprise one or more central light source(s) 339. In these or other embodiments, support substructure(s) 325 (e.g., first support substructure 326 and second support substructure 327) can be mirrored about a central vertical plane of support structure 323. Accordingly, central light source(s) 339 can be interpositioned between first support substructure 326 and second support substructure 327 so that first bioreactor 328 and second bioreactor 329 each can receive light from central light source(s) 339.

In implementation, light source(s) 337 (e.g., frame light source(s) 338 and/or central light source(s) 339) can comprise one or more banks of light bulbs and/or light emitting diodes. In some embodiments, light source(s) 337 (e.g., the light bulbs and/or light emitting diodes) can emit one or more wavelengths of light, as desirable for the particular organism(s) being vitally supported by bioreactor(s) 324.

In some embodiments, the one or more light sources 337 may be provided on one side of the bioreactors 324, and a second side of the bioreactors 324 may have no lighting devices or may have the panels with light sources pivoted open. In one non-limiting exemplary embodiment, a system 300 can include light sources 337 on a first side and an open second side to gather natural light.

Advantageously, because each support substructure of support substructure(s) 325 can maintain a set point temperature of different ones of bioreactor(s) 324, each of bioreactor(s) 324 can be maintained at a set point temperature independently of each other. For example, when bioreactor(s) 324 are vitally supporting different types of organism(s), bioreactor(s) 324 can comprise different set point temperatures. Nonetheless, in many embodiments, bioreactor(s) 324 can comprise the same set point temperatures.

Meanwhile, in many embodiments, system 300 can comprise gas manifold 340, organic carbon material manifold 341, nutritional media manifold 342, and/or temperature maintenance fluid manifold 343. Gas manifold 340 can be operable to provide gas to one or more gas delivery fittings of bioreactor(s) 324. The gas delivery fitting(s) can be similar or identical to gas delivery fitting(s) 107 (as shown in FIG. 1) and/or gas delivery fitting(s) 207 (as shown in FIG. 2). Further, organic carbon material manifold 341 can be operable to deliver organic carbon material to one or more organic carbon material delivery fittings of bioreactor(s) 324. The organic carbon material delivery fitting(s) can be similar or identical to organic carbon material delivery fitting(s) 111 (as shown in FIG. 1) and/or organic carbon material delivery fitting(s) 211 (as shown in FIG. 2). Further still, nutritional media manifold 342 can be operable to provide nutritional media to one or more fluidic support medium delivery fittings of bioreactor(s) 324. The fluidic support medium delivery fitting(s) can be similar or identical to fluidic support medium delivery fitting(s) 110 (as shown in FIG. 1) and/or fluidic support medium delivery fitting(s) 210 (as shown in FIG. 2). Meanwhile, temperature maintenance fluid manifold can be configured to provide the temperature maintenance fluid to the hollow conduits of first frame 330 and/or second frame 331.

Gas manifold 340, organic carbon material manifold 341, nutritional media manifold 342, and/or temperature maintenance fluid manifold 343 each can comprise one or more tubes, one or more valves, one or more gaskets, one or more reservoirs, one or more pumps, and/or control logic (e.g., one or more computer processors, one or more transitory memory storage modules, and/or one or more non-transitory memory storage modules) configured to perform their respective functions. In these embodiments, the control logic can communicate with one or more parameter sensing devices of bioreactor(s) 324 to determine when to perform their respective functions (i.e., according to the needs of the organism(s) being vitally supported by bioreactor(s) 324). The parameter sensing device(s) can be similar or identical to parameter sensing device(s) 109 (as shown in FIG. 1).

FIG. 4 illustrates a system 400, according to an embodiment. System 400 is a non-limiting example of system 300 (as shown in FIG. 3). Yet, system 400 of FIG. 4 can be modified or substantially similar to the system 300 of FIG. 3 and such modifications can be selected by one or ordinary skill in the art without departing from the scope of this innovation.

System 400 can comprise support structure 423, first support substructure 426, second support substructure 427, first frame 430, second frame 431, first frame rails 434, second frame rails 435, and one or more light source(s) 437. In these embodiments, light source(s) 437 can comprise one or more frame light sources 438. In many embodiments, support structure 423 can be similar or identical to support structure 323 (as shown in FIG. 3); first support substructure 426 can be similar or identical to first support substructure 326 (as shown in FIG. 3); second support substructure 427 can be similar or identical to second support substructure 327 (as shown in FIG. 3); first frame 430 can be similar or identical to first frame 330 (as shown in FIG. 3); second frame 431 can be similar or identical to second frame 331 (as shown in FIG. 3); first frame rails 434 can be similar or identical to first frame rails 334 (as shown in FIG. 3); second frame rails 435 can be similar or identical to second frame rails 335 (as shown in FIG. 3); and/or light source(s) 437 can be similar or identical to light source(s) 337 (as shown in FIG. 3). Further, frame light source(s) 438 can be similar or identical to frame light source(s) 338.

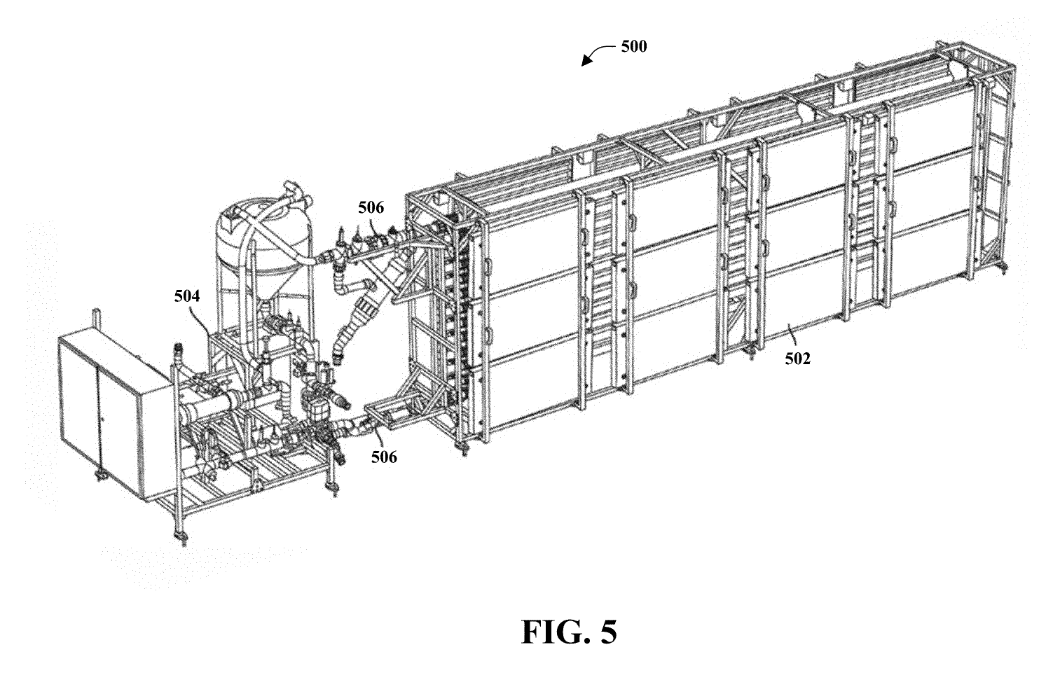

FIG. 5 illustrates an embodiment of a modular bioreactor system 500. In one embodiment, a self-contained bioreactor system for culturing microorganisms in an aqueous medium comprises a modular bioreactor system. The modular bioreactor system comprises a plurality of modular components which may be easily coupled together into a functioning system and decoupled for repair, replacement, upgrading, shipping, cleaning, or reconfiguration. The interchangeability of the modular components allows components of a bioreactor system to be easily transported and assembled at multiple locations, as well as to change the capacity of the bioreactor system or change the functionality of the bioreactor system. Each module is a standalone unit that may be interchanged with other modular bioreactor systems for different configurations, providing the benefit of flexibility over conventional single configuration integrated bioreactor systems.

In some embodiments, the modular components may be decoupled when the modular bioreactor system contains an aqueous culture of microorganisms, while maintaining isolated volumes of the aqueous microorganism culture in the various individual modular components without exposing the culture of microorganisms to the environment or outside contamination. With the ability to maintain an isolated volume of the aqueous culture, modules may be interchanged in the event of equipment malfunction without necessitating harvest or enduring a complete loss of the microorganism culture. Additionally, an isolated volume of the aqueous microorganism culture may be transported to different locations for different operations, such as growth, product maturation (e.g., lipid accumulation, pigment accumulation), harvest, dewatering, etc. The modular components may couple and decouple from each other using pipe or tubular quick connect couplers which may be quickly coupled by hand to allow fluid communication between modular components and quickly decoupled in a manner which also self-seals any fluid communication, effectively sealing an isolated volume of the aqueous culture in each modular component. The quick connect couplers may comprise fluid conduit couplers known in the art such as, but not limited to, cam lock couplers.

A non-limiting exemplary embodiment of a modular bioreactor system 500 is shown in FIG. 5. FIG. 5 shows a modular bioreactor system 500 with a bioreactor module 502, cleaning module 504, and pump and control module 506 coupled together in fluid communication. It is to be appreciated that the modular bioreactor system 500 with a bioreactor module 502, cleaning module 504, and pump and control module 506 can be decoupled from each other. As an example, one or more couplers between the modules may comprise quick connection couplers such as, but not limited to cam lock couplers, capable of self-sealing an isolated volume of an aqueous culture medium in each individual module. In some embodiments of the modular bioreactor system 500, the couplers may comprise traditional couplers such as, but not limited to, threaded connections or bolted together flange connections.

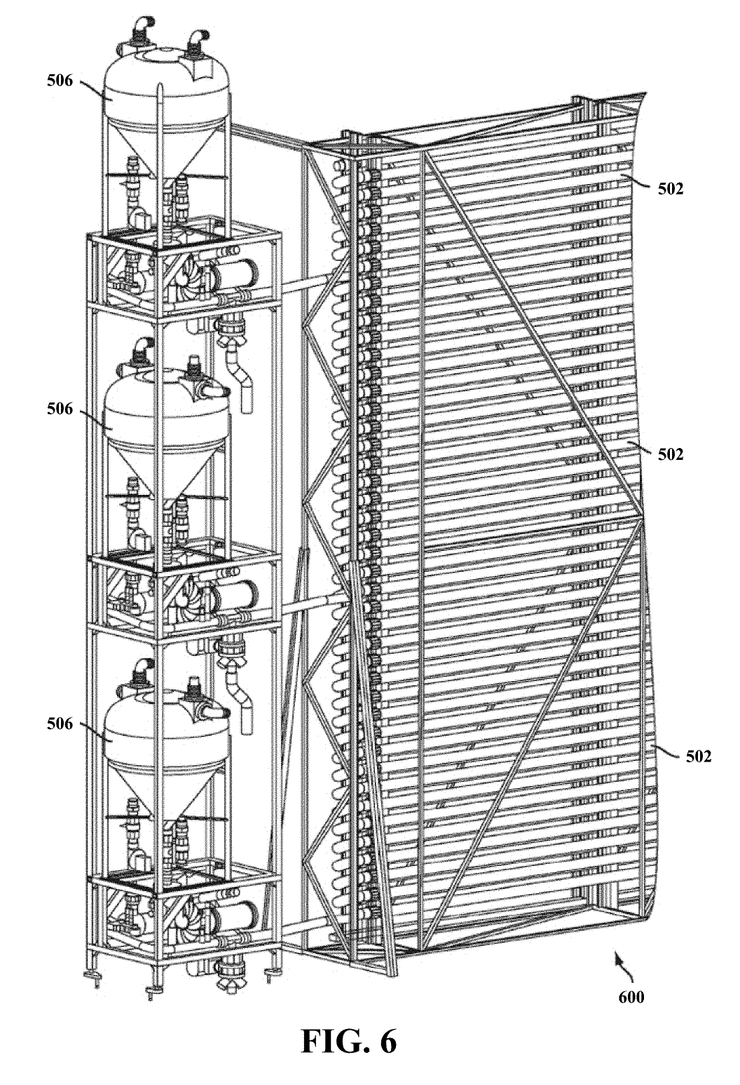

FIG. 6 illustrates a non-limiting exemplary embodiment of a cascading transfer bioreactor system 600 with multiple bioreactor modules 502 and multiple pump and control modules 506. The cascading transfer bioreactor system 600 can include modular bioreactors may be used as a production platform, as a seed reactor platform, or a combination of both. The cascading transfer bioreactor system 600 may be used in a system that connects the seed production with one or more larger volume downstream production reactors. The cascading transfer bioreactor system 600 may be partially or fully harvested to inoculate a larger seed reactor. The cascading transfer bioreactor system 600 may be used as a finishing step for the production of products that require a two-step growth process to produce pigments or other high value products.

In an alternate embodiment, the cascading transfer bioreactor system 600 may comprise culture tube segments that have different diameters, where a small diameter is used for a preferentially phototrophic section while a larger tubular diameter is used for a preferably mixotrophic section. The segments with different culture tube diameters may be interleaved and connected in a way to enhance turbulence or mixing in the system without the use of a high Reynolds numbers such that the overall system pressure drop is reduced.

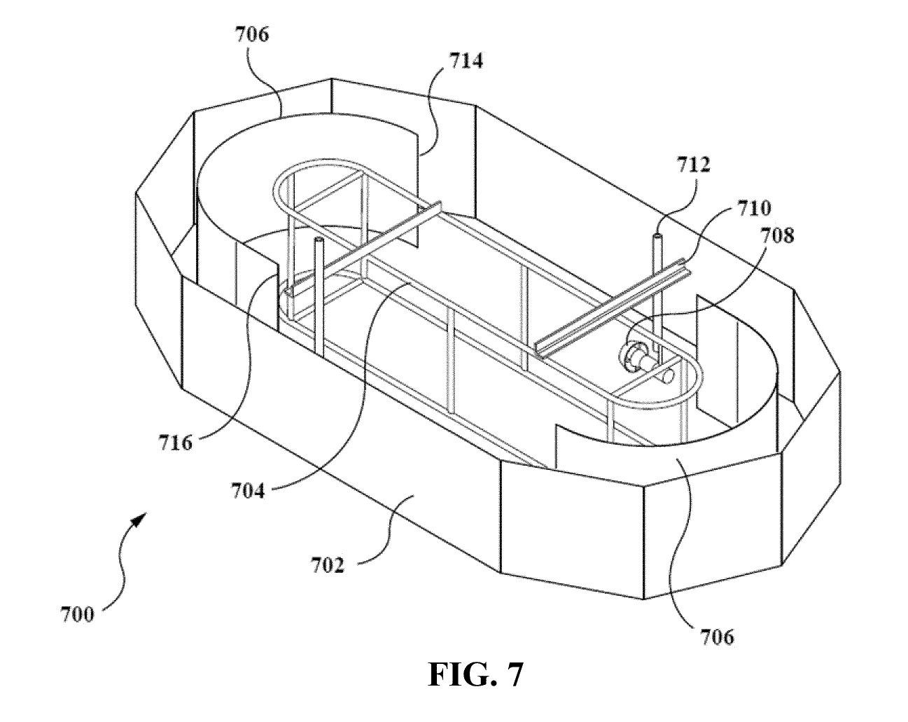

Turning to FIG. 7, a non-limiting embodiment of the open raceway pond bioreactor 700 is illustrated. The open raceway pond bioreactor 700 comprises an outer wall 702, center wall 704, arched turning vanes 706, submerged thrusters 708, support structure 710 (horizontal), and 712 (vertical). The outer wall 702 and the center wall 704 form the boundaries of the straight away portions and U-bend portions of the bioreactor 700. The center wall 704 is shown as a frame for viewing purposes, but in practice panels are inserted into open sections of the frame or a liner placed over the frame to form a solid center wall surface. Also, the outer wall 702 of the bioreactor 700 is depicted as multiple straight segments connected at angles to form the curved portion of the U-bend, but the outer wall 702 may also form a continuous curve or arc.

The arched turning vanes 703 can have an asymmetrical shape having a first end 714 of the turning vane at the beginning of the U-bend portion and a second end 716 extending past the U-bend portion into the straight away portion. The flow path of the culture in the open raceway pond bioreactor 700 would be counter clockwise, with the culture encountering first end 714 of the turning vane first, second end 716 of the turning vane second, and then the submerged thruster 708 when traveling through the U-bend portion and into the straight away portion. The arched turning vanes 706 are also shown in to be at least as tall as the center wall 704, to allow a portion of the arched turning vanes 706 to protrude from the culture volume when operating.

The present invention involves the use of a microalgae composition. Microalgae compositions, methods of preparing liquid microalgae compositions, and methods of applying the microalgae compositions to plants are disclosed in WO2017/218896A1 (Shinde et al.) entitled Microalgae-Based Composition, and Methods of its Preparation and Application to Plants, which is incorporated herein in full by reference. In one or more embodiments, the microalgae composition may comprise approximately 10% w/w of Chlorella microalgae cells. In one or more embodiments, the microalgae composition may also comprise one of more stabilizers, such as potassium sorbate, phosphoric acid, ascorbic acid, sodium benzoate, citric acid, or the like, or any combination thereof. For example, in one or more embodiments, the microalgae composition may comprise approximately 0.3% of potassium sorbate or another similar compound to stabilize its pH and may further comprise approximately 0.5-1.5% phosphoric acid or another similar compound to prevent the growth of contaminants. As a further example, in one or more embodiments where it is desired to use an OMRI (Organic Materials Review Institute) certified organic composition, the microalgae composition may comprise 1.0-2.0% citric acid to stabilize its pH.

### EXAMPLES

### Example 1

For this example, microalgae composition was prepared by using Chlorella microalgae cells. The Chlorella cells are pasteurized at between 65° C.-75° C. for between 90-150 minutes. Pasteurization of the Chlorella microalgae cells ensures that the Chlorella microalgae cells are dead and inactive in the microalgae composition, and therefore do not interact with the environment when combined with the biochar and placed in the soil. Pasteurization of the Chlorella microalgae cells also helps to ensure that any bacteria that would be harmful to the soil and/or the plant growing in the soil are eliminated from the microalgae composition. The microalgae composition may comprise approximately 10% w/w of Chlorella microalgae cells. Furthermore, the microalgae composition may comprise between approximately 1.0%-2.0% citric acid stabilizer. Although this particular microalgae composition was used for this example, it should be clearly understood that other variations of the microalgae composition, including variations in the microalgae strains, variations in the stabilizers, and/or variations in the % composition of each component may be used and may achieve similar results.

In this example, the charging capacities of two charging methods were determined. Furthermore, the effects of the resulting pre-charged biochar on soil health through soil active carbon, soil protein content, and soil water holding capacity and the quality of run-off water (total dissolved solids and total suspended solids) using a soil pot platform in a research greenhouse were also determined.

According to one charging method, 100 g of dried raw biochar was pre-seasoned with fresh water for 24 hours. Then, 2 L of the 10% w/w microalgae composition (containing 200 g of solid microalgae cells) was added for another 24 hours at 37° C. with purging. Alternatively, the 2 L of microalgae composition was added for a period of 7 days at room temperature (i.e. 20-25° C.) with purging. In this experiment, the microalgae composition was added all at once; however, it should be clearly understood that substantial benefit may still be derived from the microalgae composition having been added in increments. The mixture was harvested with pre-weighted cheesecloth and rinsed 5 times with cold water until no algae residue was visible in the run-off water. The combination (microalgae+biochar) was dried at 75° C.-105° C. until it reached a constant weight, 105° C. being preferred. Variation in drying temperature would alter the drying time. For example, drying at 105° C. would take approximately 145 minutes, whereas drying at 75° C. may take about 6-8 hours.

According to the second charging method, 100 g of dried raw biochar was directly added to 2 L of the 10% w/w microalgae composition (containing 200 g of solid microalgae cells) for 24 hours at 37° C. with purging. Alternatively, the 2 L of microalgae composition was added for a period of 7 days at room temperature (i.e. 20-25° C.) with purging. The mixture was harvested with pre-weighted cheesecloth rinsed 5 times with water until no algae residue was visible in the run-off water. The combination was dried at 75° C.-105° C. until it reached a constant weight, 105° C. being preferred. Variation in drying temperature would alter the drying time. For example, drying at 105° C. would take approximately 145 minutes, whereas drying at 75° C. may take about 6-8 hours.

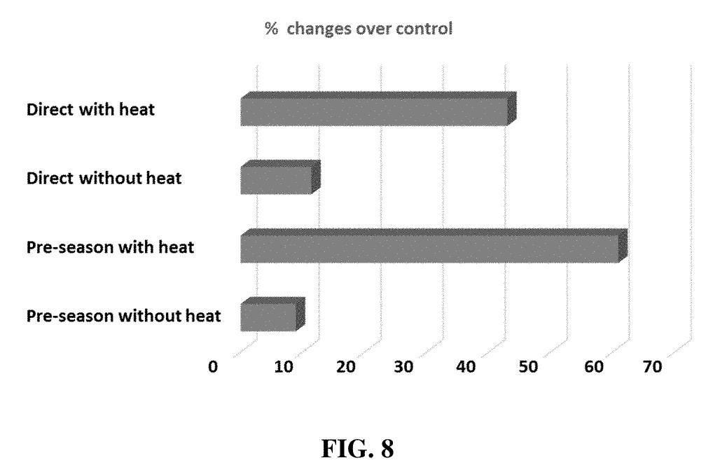

The results of the experiment are shown in FIG. 8 and Table 1 below.

TABLE 1
% Charging Effect in Mass Over the Control

| Methods | % charging over Control |
|---|---|
| Pre-season without heat | 8.9 |
| Pre-season with heat | 60.9 |
| Direct without heat | 11.4 |
| Direct with heat | 43 |

FIG. 8 shows the results of: 1) directly charging raw biochar at room temperature; 2) directly charging raw biochar with heat (i.e. incubated at 37° C.); 3) pre-seasoning the raw biochar and then charging the raw biochar at room temperature; and 4) pre-seasoning the raw biochar and then charging the raw biochar with heat (i.e. incubated at 37° C.). As shown, using the method wherein raw biochar was pre-seasoned before incubating it with the microalgae composition at 37° C. yielded an increase of approximately 61% in mass over the control (i.e. raw biochar). Furthermore, using the method wherein raw biochar was directly charged with the microalgae composition at 37° C. yielded a 43% mass increase over the control. These increases in mass indicate that the mass of the biochar had increased due to its having absorbed the microalgae and healthy microbiomes into its pores. Still further, for both methods (pre-seasoning and directly charging) it is shown that incubating the mixture of biochar and the microalgae composition at 37° C. achieved higher increases in % mass over the control than each respective method achieved without heating the mixture. Overall, there was a noticeable biochar grain size difference between raw biochar and the biochar that was pre-charged with the microalgae composition (whether pre-seasoned or directly charged).

### Example 2

For this example, the microalgae composition was prepared by using Chlorella microalgae cells. The Chlorella cells are pasteurized at between 65° C.-75° C. for between 90-150 minutes. Pasteurization of the Chlorella microalgae cells ensures that the Chlorella microalgae cells are dead and inactive in the microalgae composition, and therefore do not interact with the environment when combined with the biochar and placed in the soil. Pasteurization of the Chlorella microalgae cells also helps to ensure that any bacteria that would be harmful to the soil and/or the plant growing in the soil are eliminated. The microalgae composition may comprise approximately 10% w/w of Chlorella microalgae cells. Furthermore, the microalgae composition may comprise between approximately 1.0%-2.0% citric acid stabilizer. Although this particular microalgae composition was used for this example, it should be clearly understood that other variations of the microalgae composition, including variations in the microalgae strains, variations in the stabilizers, and/or variations in the % composition of each component may be used and may achieve similar results.

In order to evaluate the effect of the microalgae charged biochar on soil health, a “soil only” experiment was conducted and incorporated with a single application of all test subjects, wherein the “soil only” plots were treated with city water alone. Soil from an alfalfa field was identified as Antho sandy loam. Antho sandy loam is a type of soil that is made up of sand along with varying amounts of silt and clay. Antho sandy loam may be characterized as being very deep and somewhat excessively drained soils. The soil was collected and run through an 8 mm sieve to ensure texture consistency. Each quart pot was filled with 950 ml of soil. Each test subject was run in triplicate and received a 1% v/v pre-treatment. For the soil treated with the microalgae composition only, each pot was drenched with 210 ml of microalgae composition treatment solution; 210 ml was the saturation point. For soil treated with the 1% v/v pre-charged biochar, 9.5 ml of the pre-charged biochar was laid at 2″ depth of the soil bed because where 950 ml of soil and 1% v/v pre-charged biochar are used, this creates a 1:1 ratio of soil to pre-charged biochar. Although the pre-charged biochar was laid at 2″ depth in the quart pot, it should be clearly understood that the ideal depth when applying pre-charged biochar to the soil in the field would be between 2-6 inches; i.e. beneath the organic layer of the soil. The pre-charged biochar should be positioned at a depth within the soil that will accommodate for the root length of the targeted crop; e.g. strawberries have longer roots (about 6 inches long) and lettuce has shorter roots (about 2 inches long). The final array of pots was incubated in a greenhouse for 30 days. Soil protein content was quantified using the sodium citrate assay; active carbon content was quantified using the potassium permanganate oxidation assay; the soil water-holding capacity assay was adapted from the Keen-Raczkowski Box Method, and gravitation methods were used to measure total suspended solids (TSS) and total dissolved solids (TDS) from run-off water. Table 2 below shows the detailed average soil health metrics data generated at each sampling day from different treatments.

TABLE 2
Average Soil Health Metrics Data Generated
from Each Treatment at Every Sampling Day

| | | | Active | Soil | Water | | |
|---|---|---|---|---|---|---|---|
| Sampling | | N | Carbon | Protein | holding | TSS | TDS |
| days | Treatments | Rows | (mg/kg) | (mg/g) | capacity % | (ppm) | (ppm) |
| 0 | UTC | 3 | 164.38 | 2.27 | 47.25 | 5464.00 | 733.33 |
| 15 | UTC | 3 | 175.49 | 1.12 | 50.15 | 5744.00 | 1266.67 |
| 30 | UTC | 3 | 47.01 | 1.46 | 44.70 | 7781.33 | 1800.00 |
| 0 | Raw Biochar | 3 | 164.38 | 2.27 | 47.25 | 5464.00 | 733.33 |
| 15 | Raw Biochar | 3 | 131.33 | 1.19 | 49.56 | 4736.00 | 1333.33 |
| 30 | Raw Biochar | 3 | 40.38 | 1.57 | 47.36 | 1221.33 | 1466.67 |
| 0 | Microalgae | 3 | 164.38 | 2.27 | 47.25 | 5464.00 | 733.33 |
| | Composition | | | | | | |
| | Only | | | | | | |
| 15 | Microalgae | 3 | 242.75 | 1.27 | 53.39 | 3553.33 | 866.67 |
| | Composition | | | | | | |
| | Only | | | | | | |
| 30 | Microalgae | 3 | 77.25 | 1.71 | 51.55 | 1005.33 | 1566.67 |
| | Composition | | | | | | |
| | Only | | | | | | |
| 0 | Microalgae | 3 | 164.38 | 2.27 | 47.25 | 5464.00 | 733.33 |
| | Charged | | | | | | |
| | Biochar | | | | | | |
| | (direct) | | | | | | |
| 15 | Microalgae | 3 | 177.52 | 1.22 | 49.89 | 4952.00 | 1200.00 |
| | Charged | | | | | | |
| | Biochar | | | | | | |
| | (direct) | | | | | | |
| 30 | Microalgae | 3 | 40.91 | 1.55 | 51.18 | 5550.67 | 1500.00 |
| | Charged | | | | | | |
| | Biochar | | | | | | |
| | (direct) | | | | | | |
| 0 | Microalgae | 3 | 164.38 | 2.27 | 47.25 | 5464.00 | 733.33 |
| | Charged | | | | | | |
| | Biochar (pre- | | | | | | |
| | soak) | | | | | | |
| 15 | Microalgae | 3 | 182.85 | 1.32 | 52.82 | 4654.67 | 1133.33 |
| | Charged | | | | | | |
| | Biochar (pre- | | | | | | |
| | soak) | | | | | | |
| 30 | Microalgae | 3 | 81.22 | 1.69 | 51.42 | 1398.67 | 1466.67 |
| | Charged | | | | | | |
| | Biochar (pre- | | | | | | |
| | soak) | | | | | | |

Table 3 below shows the highlighted relative percentage change in active carbon, soil protein, and water holding capacity for the microalgae composition alone and the microalgae charged biochar combination in comparison to the Untreated Control (UTC) at each sampling point.

TABLE 3
Relative Percentage Change in Active Carbon, Soil
Protein, and Water Holding Capacity for Microalgae
Composition alone and Microalgae Charged Biochar Combination
Compared to UTC at Each Sampling Point

| Sam- | | | Active | Soil | Water |
|---|---|---|---|---|---|
| pling | | N | Carbon | Protein | Holding |
| days | Treatments | Rows | % | % | Capacity % |
| 0 | Raw Biochar | 3 | 0.00 | 0.00 | 0.00 |
| 15 | Raw Biochar | 3 | −25.16 | 6.00 | −1.19 |
| 30 | Raw Biochar | 3 | −14.10 | 7.69 | 5.93 |
| 0 | Microalgae Composition | 3 | 0.00 | 0.00 | 0.00 |
| | Only | | | | |
| 15 | Microalgae Composition | 3 | 38.32 | 12.88 | 6.45 |
| | Only | | | | |
| 30 | Microalgae Composition | 3 | 64.31 | 16.95 | 15.31 |
| 0 | Microalgae Charged | 3 | 0.00 | 0.00 | 0.00 |
| | Biochar (direct) | | | | |
| 15 | Microalgae Charged | 3 | 1.16 | 8.42 | −0.54 |
| | Biochar (direct) | | | | |
| 30 | Microalgae Charged | 3 | −12.97 | 5.89 | 14.48 |
| | Biochar (direct) | | | | |
| 0 | Microalgae Charged | 3 | 0.00 | 0.00 | 0.00 |
| | Biochar (pre-soak) | | | | |
| 15 | Microalgae Charged | 3 | 4.19 | 17.51 | 5.31 |
| | Biochar (pre-soak) | | | | |
| 30 | Microalgae Charged | 3 | 72.77 | 15.89 | 15.02 |
| | Biochar (pre-soak) | | | | |

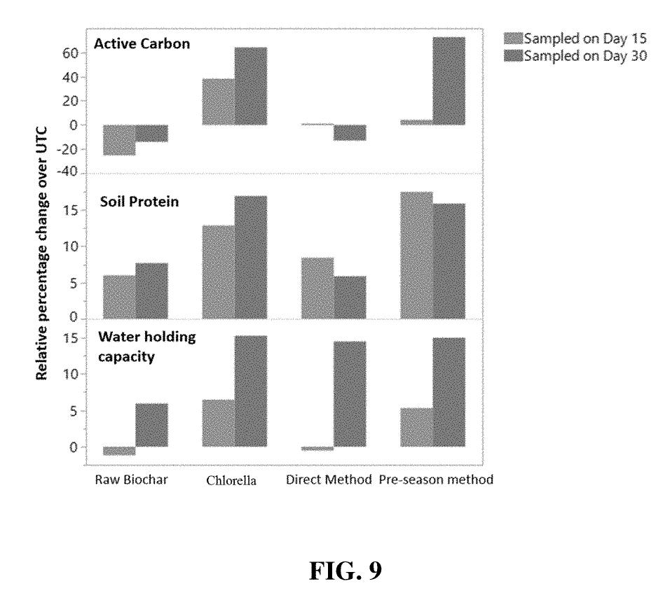

FIG. 9 shows the relative percentage change over the UTC in active carbon, soil protein, and water holding capacity for soil treated with: 1) raw biochar; 2) microalgae composition alone; 3) pre-seasoned biochar pre-charged with microalgae composition; and 4) biochar pre-charged directly with microalgae composition. The data revealed a similar pattern between the effects of biweekly application of the microalgae composition alone on soil and the effects of the biweekly application of biochar pre-charged with microalgae composition (via pre-seasoning method) on soil. The data also revealed that the pre-seasoning method of charging biochar with the microalgae composition had superior effects on soil health as compared to the direct charging method of charging biochar and as further compared to the simple use of raw biochar.

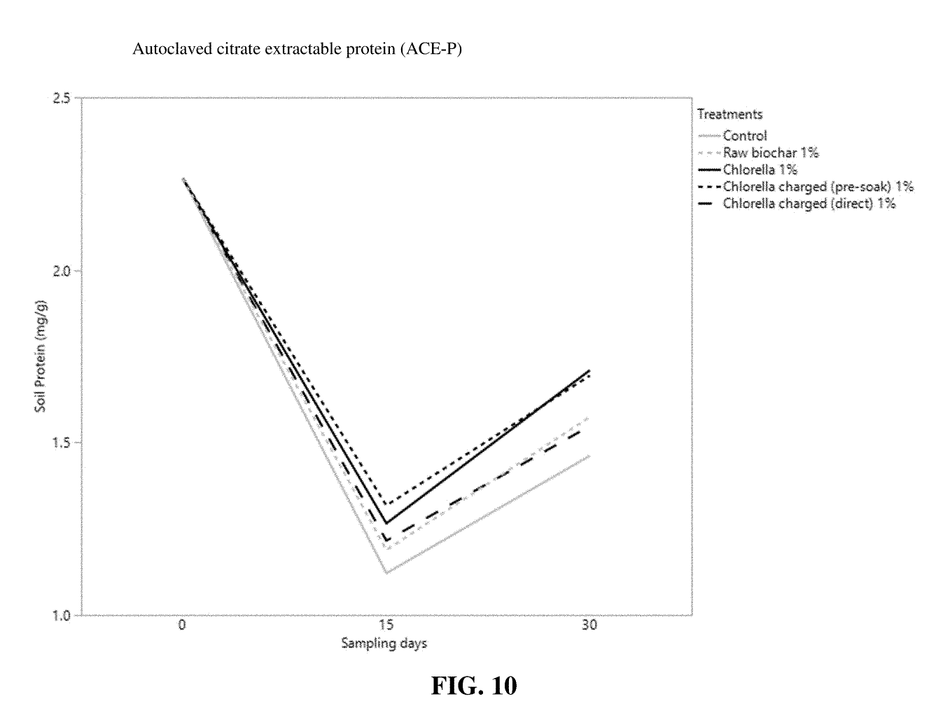

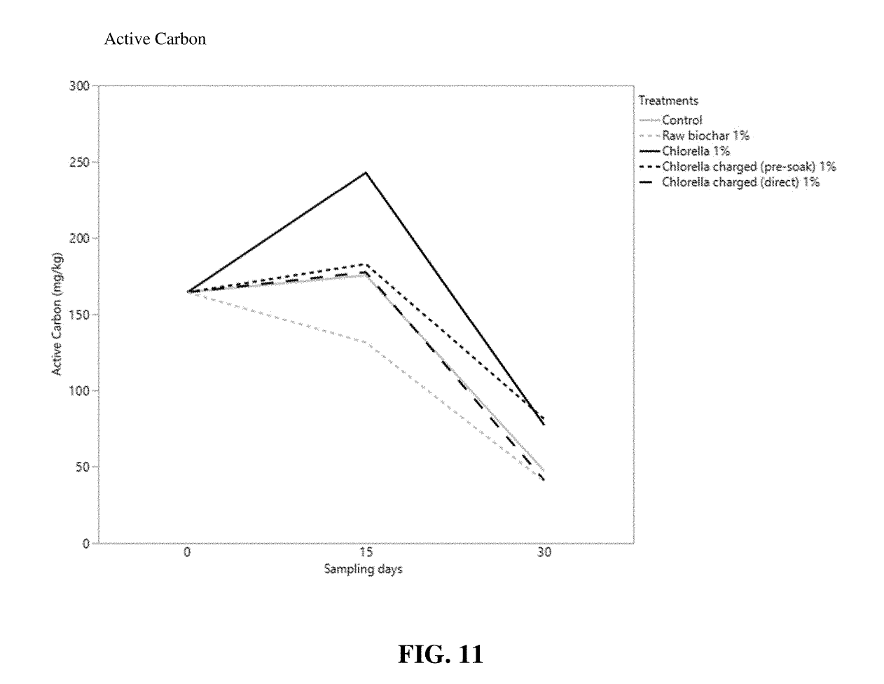

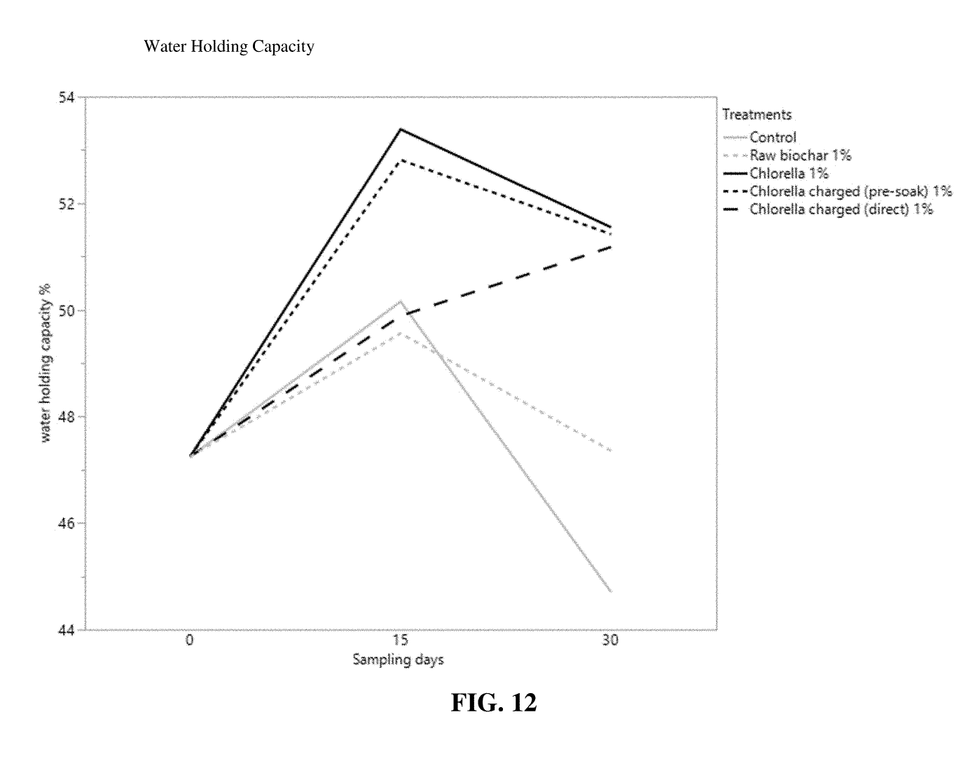

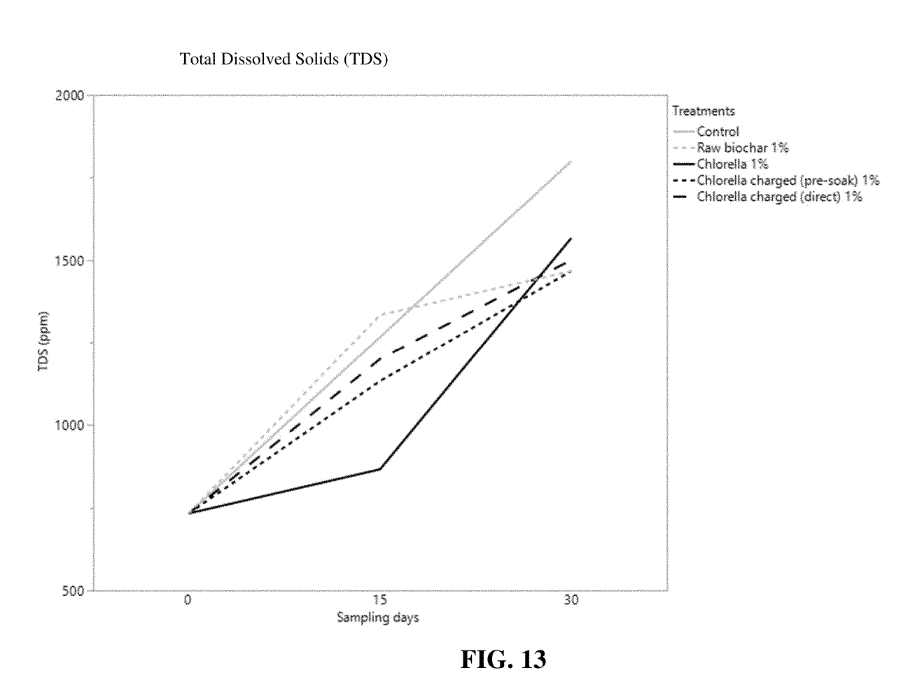

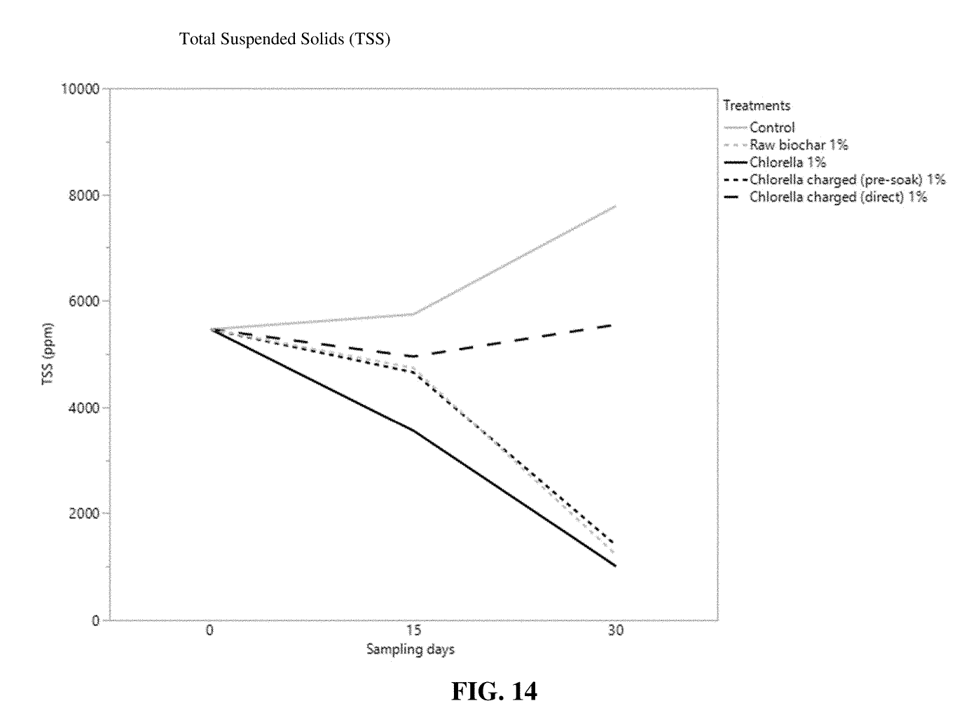

FIGS. 10-14 show soil health metrics trendlines individually. FIG. 10 shows that the soil protein levels for soils that were treated only with the microalgae composition and soils that were treated with the microalgae charged biochar (via pre-seasoning method) at 1% v/v were observed to have significantly higher soil protein levels than the untreated control (UTC) 15 days after application. FIG. 11 shows that the active carbon levels for soils that were treated only with the microalgae composition and soils that were treated with the microalgae charged biochar (via pre-seasoning method) at 1% v/v were observed to have significantly higher soil active carbon levels than the UTC and raw biochar starting at 15 days after application. FIG. 12 shows that the water holding capacity (WHC) for soil treated only with the microalgae composition and soils treated with the microalgae charged biochar (via pre-seasoning method) at 1% v/v were observed to have significantly higher WHC levels than the UC and raw biochar starting at 15 days after application. FIG. 13 shows that the total dissolved solids (TDS) from run-off water for soil treated only with the microalgae composition at 1% v/v was observed to be significantly lower than the UTC and raw biochar at 15 days after application. At 15 days and at 30 days, the TDS from run-off water for soil treated with microalgae pre-charged biochar were also lower than the UTC and raw biochar. FIG. 14 shows that the total suspended solids (TSS) from run-off water for soil treated only with the microalgae composition, soils that were treated with the microalgae pre-charged biochar (via pre-seasoning method), and soils that were treated with the microalgae pre-charged biochar (via direct charging method) at 1% v/v were observed to be significantly lower than the UTC starting from 15 days after application. Together, FIGS. 10-14 show that, in Antho sandy loam soil, pre-seasoned biochar pre-charged with microalgae composition provide a statistically significant increase in soil active carbon, soil protein, and soil water-holding capacity over the untreated control (i.e. soil only) in as little as 15 days post application.

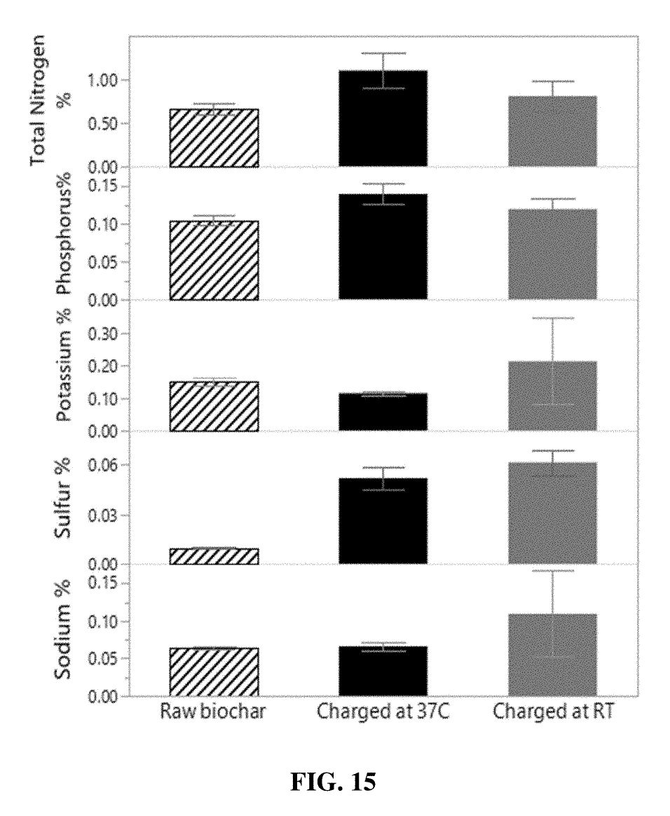

FIG. 15 is a diagram of a chemical analysis that compares the levels of nitrogen (N), phosphorus (P), potassium (K), sodium (Na), and sulfur (S) in the following scenarios: 1) raw biochar; 2) an alternative commercially available processed biochar; 3) an alternative commercially available processed biochar that has been charged again with the microalgae composition and heated at 37° C.; 4) raw biochar pre-charged with microalgae composition (pre-seasoning method with heat); and 5) raw biochar pre-charged with microalgae composition (pre-seasoning method without heat). Raw data is included in Table 4 below. As shown, pre-charged biochar showed increased levels of nitrogen and phosphorus in the soil compared to the UTC (raw biochar). It is also shown that pre-charging raw biochar with the pre-seasoning method and heat (incubating the mixture of microalgae composition with raw biochar at 37° C.), resulted in pre-charged biochar containing much higher levels of nitrogen and phosphorus, compared to the UTC (raw biochar). The alternative commercially available processed biochar product did not appear to be affected much by the charging method disclosed herein because it is already a pre-charged biochar product.

TABLE 4
Relative Percentage Change in Total Nitrogen, Phosphorus, Potassium, Sulfur,
Sodium for Microalgae Charged Biochar Combination Compared to UTC at Each
Sampling Point

| | | Total | | | | |
|---|---|---|---|---|---|---|
| | | Nitrogen, | Phosphorus, | Potassium, | | Sodium, |
| Description | Treatments | N (%) | P2O5 (%) | K2O (%) | Sulfur, S (%) | Na (%) |
| Raw biochar | Raw biochar | 0.623 | 0.11 | 0.14 | 0.01 | 0.062 |
| Raw biochar | Raw biochar | 0.711 | 0.1 | 0.16 | 0.0092 | 0.065 |
| Pre-season 37 | Chlorella charged | 1.246 | 0.15 | 0.12 | 0.057 | 0.07 |
| Pre-season 37 | Chlorella charged | 0.958 | 0.13 | 0.11 | 0.047 | 0.062 |
| Pre-season RT | Chlorella charged | 0.936 | 0.13 | 0.12 | 0.056 | 0.069 |
| Pre-season RT | Chlorella charged | 0.678 | 0.11 | 0.31 | 0.067 | 0.15 |

As shown by Example 1 and Example 2, it is apparent that the type of charging method (pre-seasoning versus direct charging) and the charging temperature strongly influence the potential charging ability of the raw biochar. Particularly, an increase in the incubation temperature (i.e. increasing from room temperature to about 37° C.) improved the absorption properties of the raw biochar, such as its surface area and porosity, which potentially helped to charge the raw biochar with the microalgae composition and healthy microbes within 24 hours. The enhanced biochar physicochemical properties could cause changes in the soil nutrient and carbon (C) availability and also provide physical protection to microorganisms which may alter the microbial diversity of the soil.

Although a particular feature of the disclosed techniques and systems may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the inventive concepts, including the best mode, and also to enable one of ordinary skill in the art to practice the inventive concepts, including making and using any devices or systems and performing any incorporated methods. The patentable scope of the inventive concepts is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the inventive concepts has been described for purposes of illustrating the best mode known to the applicant at the time and enable one of ordinary skill in the art to practice the inventive concepts, including making and using devices or systems and performing incorporated methods. The examples are illustrative only and not meant to limit the inventive concepts, as measured by the scope and merit of the claims. The inventive concepts have been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the inventive concepts is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto. All patents and references cited herein are explicitly incorporated by reference in their entirety.

What is claimed is:

1. A method of pre-charging biochar with microalgae for use in soil comprising the steps of:
providing an amount of raw biochar;
providing an amount of a liquid microalgae composition;
mixing the raw biochar with the liquid microalgae composition to create a pre-charging mixture;
incubating the pre-charging mixture for between 12-24 hours to create pre-charged biochar;
drying the pre-charged biochar; and
burying an effective amount of the pre-charged biochar in soil within the vicinity of a fruiting plant, seedling, or seed.

2. The method of claim 1 wherein the liquid microalgae composition comprises approximately 10% by weight of dead pasteurized Chlorella microalgae cells and between about 0.3%-2.0% by weight of a stabilizer, wherein the stabilizer is at least one of potassium sorbate, phosphoric acid, and citric acid.

3. The method of claim 2 wherein the pre-charging mixture comprises a 1:2 ratio of raw biochar to Chlorella microalgae cells.

4. The method of claim 1 wherein the step of incubating further comprises the steps of:
heating the pre-charging mixture at a temperature between 24° C.-60° C. for between 12-24 hours; and
opening pores of the raw biochar so that the microalgae composition penetrates the pores.

5. The method of claim 4 further comprising the steps of:
rinsing the pre-charged biochar after the step of incubation with cold water; and
closing the pores of the pre-charged biochar.

6. The method of claim 1 wherein the step of incubating further comprises the step of purging the pre-charging mixture by pumping atmospheric gas into the pre-charging mixture.

7. The method of claim 6 wherein the atmospheric gas is pumped into the pre-charging mixture at a flow rate of 90-120 gallons/hour.

8. The method of claim 1 wherein the liquid microalgae composition comprises nutrients beneficial to soil, the nutrients comprising at least one of nitrogen, phosphorus, potassium, sulfur, and sodium.

9. The method of claim 1 further comprising the steps of:
pre-seasoning the raw biochar before mixing the raw biochar with the liquid microalgae composition by soaking the raw-biochar in water for between 12-24 hours in water at temperature between 20° C.-25° C.; and
absorbing the water into the raw biochar and storing the water therein.

10. The method of claim 1 wherein the pre-charged biochar is buried between 2-6 inches deep within the soil.

11. The method of claim 1 wherein the step of burying an effective amount of the pre-charged biochar in soil within the vicinity of the fruiting plant, seedling, or seed leads to an increase in at least one of active carbon levels, soil protein levels, and water holding capacity for the soil.

12. A method for slow releasing nutrients into soil via pre-charged biochar comprising the steps of:
pre-charging biochar by:
providing an amount of raw biochar;
providing an amount of a liquid microalgae composition;
mixing the raw biochar with the liquid microalgae composition to create a pre-charging mixture;
incubating the pre-charging mixture for between 12-24 hours to create pre-charged biochar; and
drying the pre-charged biochar; and
burying the pre-charged biochar in the soil within the vicinity of a fruiting plant, seedling, or seed, wherein a ratio of the pre-charged biochar to the soil is 1:1.

13. The method of claim 12 wherein the step of incubating further comprises the steps of:
heating the pre-charging mixture at approximately 37° C. for between 12-24 hours;
opening pores of the raw biochar so that the microalgae composition penetrates the pores; and
purging the pre-charging mixture by pumping atmospheric gas into the pre-charging mixture at a flow rate of 90-120 gallons/hour.

14. The method of claim 12 further comprising the steps of:
rinsing the pre-charged biochar after the step of incubation with cold water; and
closing the pores of the pre-charged biochar.

15. The method of claim 12 wherein the liquid microalgae composition comprises approximately 10% by weight of dead pasteurized Chlorella microalgae cells and between about 0.3%-2.0% by weight of a stabilizer, wherein the stabilizer is at least one of potassium sorbate, phosphoric acid, and citric acid.

16. The method of claim 15 wherein the pre-charging mixture comprises a 1:2 ratio of raw biochar to Chlorella microalgae cells.

17. The method of claim 12 wherein the liquid microalgae composition comprises nutrients beneficial to soil, the nutrients comprising at least one of nitrogen, phosphorus, potassium, sulfur, and sodium.

18. The method of claim 12 further comprising the steps of:
pre-seasoning the raw biochar before mixing the raw biochar with the liquid microalgae composition by soaking the raw-biochar in water for between 12-24 hours in water at temperature between 20° C.-25° C.; and
absorbing the water into the raw biochar and storing the water therein.

19. The method of claim 12 wherein the pre-charged biochar is buried between 2-6 inches deep within the soil in order to increase at least one of active carbon levels, soil protein levels, and water holding capacity for the soil.

20. A microalgae pre-charged biochar for slow releasing nutrients into soil comprising:
an amount of raw biochar; and
an amount of a liquid microalgae composition comprising dead pasteurized Chlorella microalgae cells and nutrients beneficial to soil, the nutrients comprising at least one of nitrogen, phosphorus, potassium, sulfur, and sodium;
wherein the raw biochar is pre-charged according to the steps of:
mixing the raw biochar with the liquid microalgae composition to create a pre-charging mixture, wherein the pre-charging mixture comprises a 1:2 ratio of raw biochar to Chlorella microalgae cells;
incubating the pre-charging mixture for between 12-24 hours to create pre-charged biochar; and
drying the pre-charged biochar.
